(19) United States
(12) Patent Application Publication
(10) Pub. No.: US 2025/0324196 A1
(43) Pub. Date: Oct. 16, 2025

(54) IN-CANAL AND OTHER MICROPHONE SOUND CAPTURE AND SOUND OUTPUT, AND ASSOCIATED SYSTEMS, METHODS, DEVICES, AND NON-TRANSITORY COMPUTER-READABLE MEDIA

(71) Applicant: Iyo Inc., Redwood City, CA (US)

(72) Inventors: Neil David Treat, Los Gatos, CA (US); Kyle Steven Hoefer, Santa Clara, CA (US); Jason Steven Rugolo, Gilbert, AZ (US)

(73) Assignee: Iyo Inc., Redwood City, CA (US)

(21) Appl. No.: 19/097,807

(22) Filed: Apr. 1, 2025

Related U.S. Application Data
(60) Provisional application No. 63/633,611, filed on Apr. 12, 2024.

(51) Int. Cl. H04R 3/00; H04R 1/10; H04R 25/00

(52) U.S. Cl. CPC H04R 3/005; H04R 1/1016; H04R 1/1083; H04R 25/407; H04R 25/507; H04R 25/554; H04R 2410/01; H04R 2420/07; H04R 2460/01; H04R 2460/13

(57) ABSTRACT

Utilizing in-canal microphones and other microphones in wearable devices is described. One embodiment is an ear-worn device that includes an in-canal microphone configured to capture sounds in an ear canal and an array of microphones configured to capture external sounds. The ear-worn device may utilize the in-canal microphone to determine if the user is actively speaking. Upon such a determination, the ear-worn device may turn on the array of microphones to capture the user's voice and perform beamforming to focus the array of microphones on the user's mouth. Such speech can then be processed and provided to an artificial intelligence agent. The ear-worn device may switch between using the in-canal microphone and the array of microphones to capture the user's voice depending on environmental noise, the context of the user, and the voice content. The ear-worn device may also blend captures from the in-canal microphone and the array of microphones.

### CROSS-REFERENCE TO RELATED APPLICATION

This application claims priority to U.S. Provisional Patent Application No. 63/633,611, filed on Apr. 12, 2024, and entitled “Auditory User Interfaces,” which is incorporated in its entirety herein by reference.

### TECHNICAL FIELD

The present disclosure relates in general to wearable device audio capture and playback systems, and in particular to ear-worn audio capture and playback systems that utilize in-canal microphones and other microphones to facilitate or enhance speech detection, privacy, noise cancellation, and interactions with artificial intelligence agents or other signal-processing modules or with other users, such as through telephony.

### BACKGROUND

Existing ear-worn devices, such as earbuds, may have either two external microphones or an in-ear canal microphone. An external microphone may capture speech from the user's mouth, but may also pick up ambient sound from other speakers or unwanted acoustic interference, and may not fully address confidentiality; if a user speaks at normal volume, there may still be a risk that bystanders can overhear, and the microphone may also pick up extraneous chatter. An in-ear canal microphone may suffer from limited fidelity or have difficulty capturing a robust full-spectrum speech signal for advanced processing, such as voice recognition.

Conventional voice recognition systems are primarily trained on normal-volume speech. When users whisper or when bone-conducted speech is utilized, significant high-frequency and amplitude content may be lost, degrading recognition accuracy. Moreover, privacy-conscious individuals often avoid speaking aloud in shared or public spaces, but existing systems are not tuned to capture quiet, breathy vocalizations, mumbled speech, or sub-audible or sub-vocalized speech. In sub-vocalized speech, vocal cords vibrate minimally, and many speech formants lie below typical detection thresholds. Traditional voice activity detection (VAD) and standard machine learning-based speech to text models often fail to accurately identify phonemes when speech amplitude is so low. Additionally, in-canal microphones introduce unique acoustic profiles—particularly an emphasis on bone-conducted components in sub-1 kHz frequencies—which standard STT pipelines do not fully accommodate. Accordingly, existing systems do not adequately handle whispered or near-silent speech.

In closed-back or fully occluded in-canal devices, users benefit from noise isolation and the ability to capture voice with minimal external interference. However, these advantages come at the cost of internal body noise amplification. Vibrations from speaking, chewing, or movement can resonate within the sealed ear canal, causing discomfort, distorted self-perception of voice volume (leading users to speak louder), and distracting drumming or pulsating sounds (for example, footsteps, heartbeat). Current attempts at tackling occlusion rely on partial venting or equalization, which can degrade noise cancellation quality or fail to address dynamic scenarios (for example, transitioning from stillness to activity).

No admission is necessarily intended, nor should it be construed, that any of the preceding information constitutes prior art.

### SUMMARY

This disclosure describes technology for utilizing in-canal microphones and other microphones in wearable devices. One embodiment of an aspect of the technology is an ear-worn device that includes an in-canal microphone configured to capture sounds in an ear canal and an array of microphones configured to capture external sounds. The ear-worn device may utilize the in-canal microphone to determine if the user is actively speaking. Upon such a determination, the ear-worn device may turn on the array of microphones to capture the user's voice and perform beamforming to focus the array of microphones on the user's mouth. Such speech can then be processed and provided to an artificial intelligence agent. The ear-worn device may switch between using the in-canal microphone and the array of microphones to capture the user's voice depending on environmental noise, the context of the user, and the voice content. The ear-worn device may also blend captures from the in-canal microphone and the array of microphones.

The ear-worn device may utilize the in-canal microphone for other purposes. One other purpose is to detect sub-vocalized or whispered speech through the use of signal processing techniques or customized speech to text recognition models configured to recognize sub-vocalized or whispered speech.

Another purpose the ear-worn device may utilize the in-canal microphone for is to compensate for internal body noises that may resonate within the sealed ear canal. The ear-worn device may utilize noise cancellation and adaptive equalization techniques to remove or reduce such internal sounds as well as to mitigate the sensation of the user's voice being muffled or overly loud when the user is speaking.

### BRIEF DESCRIPTION OF THE DRAWINGS

The particular arrangements shown in the Figures should not be viewed as limiting. It should be understood that the illustrated elements, including the shape, size and scale, may not necessarily be drawn in actual proportion to each other.

FIG. 1A is an exploded view of an ear-worn device that may embody aspects of the described technology.

FIG. 1B is an exploded view of a portion of the ear-worn device of FIG. 1A.

FIG. 2 depicts an example environment in which aspects of the described technology may operate in some embodiments.

FIGS. 3-10 are flow diagrams illustrating example methods that some embodiments of aspects of the described technology may perform.

FIG. 11 depicts a block diagram of an example digital device in some embodiments.

Throughout the drawings, like reference numerals will be understood to refer to like parts, components, and structures.

### DETAILED DESCRIPTION

Described herein is technology for utilizing in-canal microphones and other microphones in wearable devices for various purposes, such as interacting with artificial intelligence agents. Aspects of the technology may be embodied in wearable devices, such as ear-worn devices, and in other computing systems and devices. One embodiment of an aspect of the technology is an ear-worn device that includes an in-canal microphone configured to capture sounds or vibrations in an ear canal and an array of microphones configured to capture sounds external to the wearer of the ear-worn device.

The ear-worn device may utilize the in-canal microphone for various purposes. One purpose is to determine if the user is actively speaking. When the in-canal microphone indicates that the user is actively speaking, the ear-worn device may turn on the array of microphones to capture the user's voice and perform beamforming to focus the array of microphones on the user's mouth. The array of microphones may capture higher-fidelity speech than the in-canal microphone. Such speech can then be processed and provided to one or more artificial intelligence agents. The ear-worn device may switch between using the in-canal microphone and the array of microphones to capture the user's voice depending on various factors, such as environmental noise, the context of the user, and the content of what the user is saying. The ear-worn device may also blend or mix captures from the in-canal microphone and the array of microphones to ensure the quality of the voice capture.

Another purpose is to detect sub-vocalized or whispered speech. The ear-worn device may use customized speech to text recognition models to enable accurate low-volume speech capture. Additionally or alternatively, the ear-worn device may utilize signal processing techniques to modify the signal resulting from sub-vocalized or whispered speech so that the modified speech may be recognized by general speech to text recognition models.

Another purpose the ear-worn device may utilize the in-canal microphone for is to compensate for internal body noises that may result from speaking, chewing, or movement of the user that may resonate within the sealed ear canal. The ear-worn device may utilize noise cancellation and adaptive equalization techniques to remove or reduce unwanted internal sounds as well as to mitigate the sensation of the user's voice being muffled or overly loud.

Aspects of the described technology provide numerous improvements over existing systems. One improvement relates to improved voice activity detection and improved quality of voice captures. Another improvement relates to better recognition of whispered or sub-vocalized speech due to signal processing techniques or customized speech recognition models. Another improvement relates to mitigating or reducing occlusion effects and body-conducted sounds. Other improvements will be apparent. Accordingly, the described technology offers significant advantages over existing systems.

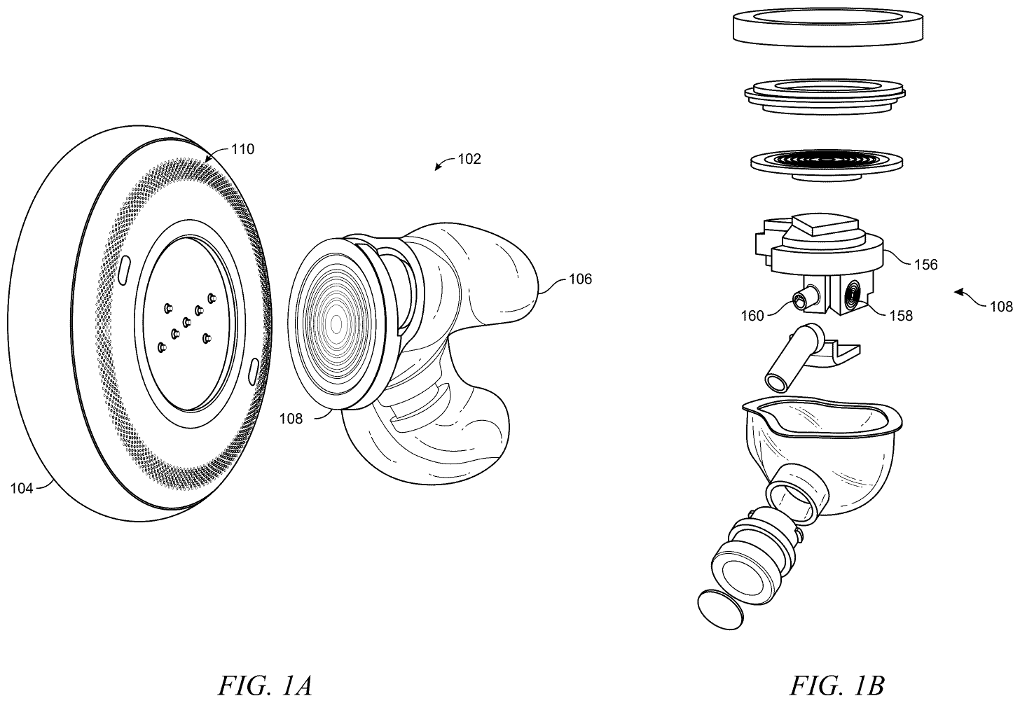

Aspects of the described technology may be embodied in wearable devices, such as ear-worn devices. FIG. 1A is an exploded view of an example ear-worn device 102 that may embody aspects of the described technology. The ear-worn device 102 includes an ear interface 106, an electronics package 104, and an acoustic package 108. The ear interface 106, which may be referred to as a soft ear interface, is made of a suitable material such as silicone. The ear interface 106 may be custom-made for a wearer of the ear-worn device 102 and provide an acoustically sealed fit when inserted into or positioned in an ear canal of the wearer. Removably positioned in the ear interface 106 is an acoustic package 108. The acoustic package 108 may include one or more analog components, such as one or more sound output devices, that are configured to output sound based on the audio signals received from the electronics package 104. The acoustic package 108 may also include one or more in-canal microphones configured to capture sounds or vibrations in the ear canal of the wearer.

The electronics package 104 removably couples to the acoustic package 108 via magnets in the electronics package 104 and the acoustic package 108. The electronics package 104 includes electronics components, including multiple microphones positioned proximate to a microphone cover. The microphone cover includes multiple perforations 110 through which air-conducted sound may travel to be captured by one or more of the multiple microphones. In some embodiments of the ear-worn device 102, there are nine microphones, eight of which are digital and one of which is analog. The eight digital microphones may be arranged in a generally circular array and be configured to capture diverse acoustic signals from various directions. The one analog microphone may be a high signal-to-noise ratio analog microphone that may be utilized for feedforward active noise cancellation. The multiple microphones may capture sounds external to the wearer of the ear-worn device 102, such as the voice of the wearer, voices of other persons, and other environmental noise. The multiple microphones may perform beamforming to capture sounds, such as the voice of the wearer.

The ear-worn device 102 may be for a left ear for a wearer, and there may be a similar ear-worn device for the right ear of the wearer. The wearer may wear both the ear-worn device 102 and the similar ear-worn device simultaneously or one of the ear-worn devices individually. U.S. Patent Application Publication No. 2024/0334112, titled “VIRTUAL AUDITORY DISPLAY DEVICES AND ASSOCIATED SYSTEMS, METHODS, AND DEVICES” and filed Mar. 29, 2024, describes the ear-worn device 102 and the similar ear-worn device in more detail, and is incorporated in its entirety herein by reference.

In some embodiments, when the ear interface 106 is positioned in an ear canal of a wearer, the ear interface 106 forms an acoustic seal that reduces or minimizes sounds from leaving or entering the ear canal. However, pressure changes, which may be caused by user movement, jaw shifts, or slight device repositioning, can degrade microphone performance and user comfort. The ear interface 106 may have one or more pressure-equalization vents to allow for static air pressure equalization between an air pressure in an ear canal of the wearer and an exterior air pressure, while still providing acoustic resistance. The one or more pressure-equalization vents may thus facilitate a stable environment for audio capture by one or more in-canal microphones.

FIG. 1B is an exploded view of the acoustic package 108. The acoustic package 108 includes multiple sound output devices, including a driver 156 and a balanced armature 160. The driver 156 may serve as a woofer and may provide a suitable low-frequency response. The balanced armature 160 may serve as a tweeter and may provide a suitable high-frequency response. The acoustic package 108 also includes an in-canal microphone 158, which may also be referred to as an in-ear canal microphone. The in-canal microphone 158 may be configured to capture the voice of the wearer in the ear canal or other sounds or vibrations. As the ear canal may be acoustically sealed due to the custom fit of the ear-worn device 102, the in-canal microphone 158 may thus provide a voice signal with minimal or reduced background noise interference.

As described in more detail herein, the ear-worn device 102 may utilize the multiple microphones in the electronics package 104 or the in-canal microphone 158 to capture sounds or vibrations, process the sounds or vibrations, and take certain actions. For example, the ear-worn device 102 may utilize the multiple microphones or the in-canal microphone 158 to capture speech of the user requesting that one or more artificial intelligence agents respond to a request. The ear-worn device 102 may receive one or more responses provided by the one or more artificial intelligence agents and generate an audio signal based on the one or more responses to be output by the driver 156 or the balanced armature 160.

As another example, the ear-worn device 102 may utilize the multiple microphones to capture external environmental noise and the multiple sound output devices to output sound corresponding to the external environmental noise to provide a transparency mode for the wearer of the ear-worn device 102. As yet another example, the ear-worn device 102 may utilize the in-canal microphone 158 to capture near-silent sounds or vibrations, such as whispered or sub-audible speech of the wearer, and process the near-silent sounds or vibrations.

Although aspects of the technology may be described as embodied in the ear-worn device 102 or in a device comprising the ear-worn device 102 and the ear-worn device for the other ear, it is to be understood that aspects of the technology may also be embodied in other ear-worn devices, such as headphones, headsets, or earbuds, as well as other wearable devices, such as augmented reality or virtual reality headsets or augmented or mixed reality glasses. Moreover, certain aspects of the technology may be embodied in or provided by non-wearable devices, such as mobile devices (for example, mobile phones, tablets, or laptops) and non-mobile devices, such as household appliances, vehicles, or desktop computer systems. Accordingly, the technology is not necessarily limited to being embodied in the ear-worn device 102 or in a device comprising the ear-worn device 102 and the ear-worn device for the other ear.

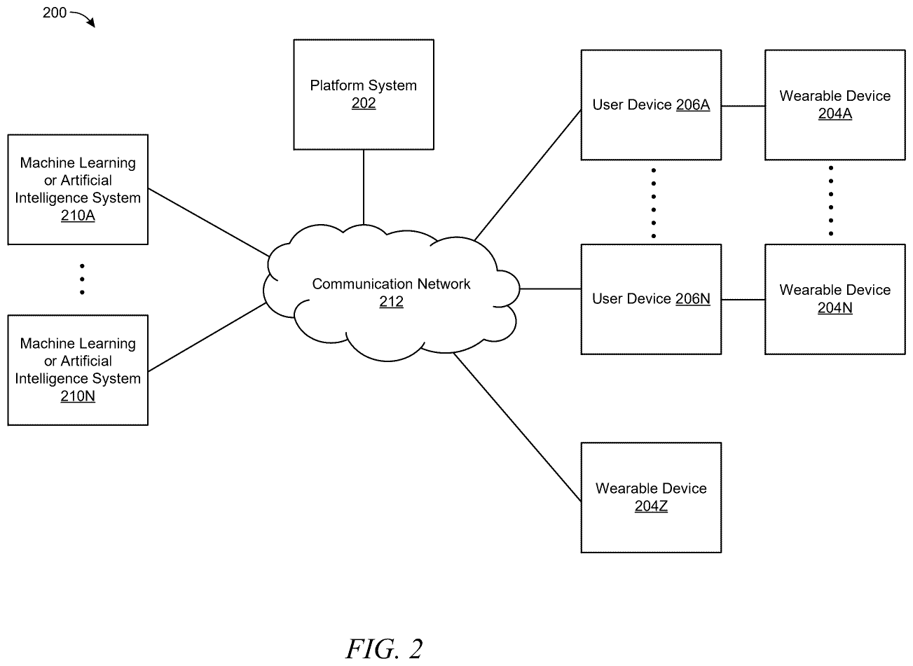

FIG. 2 depicts an example environment 200 in which aspects of the described technology may operate in some embodiments. The environment 200 includes multiple wearable devices 204, such as a wearable device 204A, a wearable device 204N, and a wearable device 204Z. The environment 200 also includes multiple user devices, such as a user device 206A and a user device 206N, a platform system 202, and multiple machine learning or artificial intelligence system 210, such as a machine learning or artificial intelligence system 210A and a machine learning or artificial intelligence system 210N. A machine learning or artificial intelligence system 210 may be or include one or more machine learning or artificial intelligence models, such as speech-to-text models such as acoustic models or language models, large language models, or other models that receive an input and provide an output based on the input or that are applied to data to process the data and provide a result. A machine learning or artificial intelligence system 210 may also be or include one or more artificial intelligence agents that utilize machine learning or artificial intelligence models or reasoning techniques to provide output, such as output in response to an input or a prompt. An artificial intelligence agent may be referred to herein as a digital assistant, a voice assistant, as an artificial agent, or as an agent or an assistant.

A wearable device 204 may need to be coupled to a user device 206 to connect to the communication network 212. For example, the wearable device 204A is illustrated as coupled to the user device 206A and the wearable device 204N to the user device 206N (for example, via a wireless connection such as Bluetooth Low Energy (BLE)). In other cases, a wearable device 204, such as the wearable device 204Z, may connect to the communication network 212 using a wireless internet connection or a wireless cellular network connection.

The wearable device 204, which may include one or more in-canal microphones configured to capture sounds or vibrations in an ear-canal of a wearer of the wearable device 204 and one or more other microphones configured to capture sounds or vibrations that are external to the wearer. The one or more other microphones may be referred to as external microphones or air-conducting microphones. The wearable device 204 may also include one or more sound output devices configured to output sounds or vibrations. The wearable device 204 may capture sounds or vibrations, process the sounds or vibrations, and take certain actions based on the sounds or vibrations. For example, the wearable device 204 may capture speech of the wearer. The wearable device 204 may digitize the speech if necessary or desired and provide the digitized (and optionally, compressed and encrypted) speech to the platform system 202 to be recognized. The platform system 202 may recognize the speech using Natural Language Processing (NLP) techniques and convert the speech to text. The platform system 202 may then determine the intent or context of the text, and identify one or more of machine learning or artificial intelligence systems 210 to provide the text or the speech to for processing and for providing a response.

The platform system 202 may receive one or more responses from one or more of the multiple machine learning or artificial intelligence systems 210 and provide the one or more responses for the wearable device 204. In some embodiments, one or more of the machine learning or artificial intelligence systems 210 may provide one or more responses for the wearable device 204 without the one or more responses passing through the platform system 202. After receiving the one or more responses from the platform system 202 or the one or more of the machine learning or artificial intelligence systems 210, the wearable device 204 may generate an audio signal based on the one or more responses to be output by the one or more sound output devices and cause the one or more sound output devices to output sound based on the audio signal.

The communication network 212 may represent one or more computer networks (for example, local area networks (LANs), wide area networks (WANs), or the like). The communication network 212 may provide or facilitate communication between any of the systems or devices illustrated in FIG. 2. In some implementations, the communication network 212 comprises computer devices, routers, cables, or other network components. In some embodiments, the communication network 212 may be wired or wireless. In various embodiments, the communication network 212 may comprise the Internet, one or more networks that may be public, private, IP-based, non-IP based, and so forth.

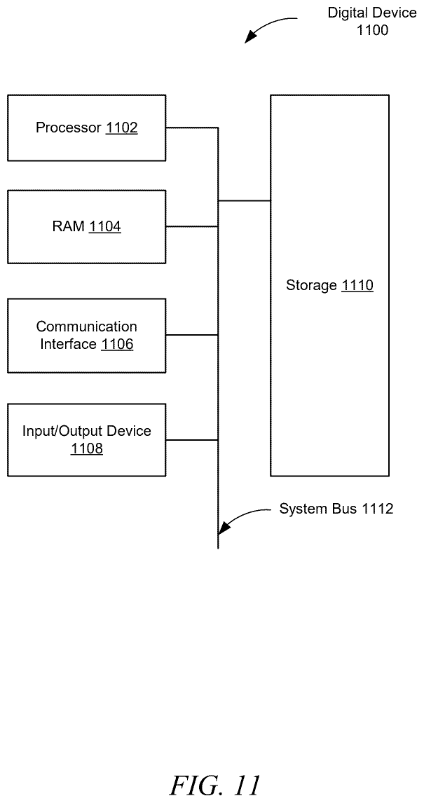

The wearable devices 204, the user devices 206, the platform system 202, and the machine learning or artificial intelligence systems 210 may be or include any number of digital devices. A digital device is any device with at least one processor and memory. Digital devices are discussed further herein, for example, with reference to FIG. 11.

It is to be understood that the environment 200 is exemplary and that aspects of the described technology may operate in other environments. Such environments may include fewer or more systems or devices than the environment 200, or such environments may be configured differently than the environment 200. For example, there may be multiple platform systems 202. Furthermore, functionality may be distributed across or provided by multiple systems or devices of the environment 200 or by other systems or devices not illustrated in FIG. 2.

### Hybrid Microphone Utilization for Speech Capture

One technical problem existing ear-worn devices have is that a microphone may capture speech from the user's mouth, but may also pick up ambient sound from other speakers or unwanted acoustic interference. Existing ear-worn devices also do not provide for confidential voice input. If a user speaks at normal volume, there is a risk that bystanders can overhear, and the microphone may also pick up extraneous chatter such as the vocalizations of the bystanders as voice input. An in-ear canal microphone may suffer from limited fidelity or have difficulty capturing a robust full-spectrum speech signal for advanced processing, such as voice recognition.

Embodiments of the described technology provide technical solutions to these technical problems. An example embodiment is the ear-worn device 102 of FIG. 1A. The ear-worn device 102 may utilize the in-canal microphone 158 to capture the wearer's speech. The ear-worn device 102 may utilize the multiple microphones in the electronics package 104 to capture external sounds. For example, in embodiments where there are nine microphones, the ear-worn device 102 may utilize the array of eight microphones to capture diverse acoustic signals from various directions, which enhances the ability of the ear-worn device 102 to isolate the primary voice signal amidst background noise. The ear-worn device 102 may utilize the single analog microphone in the electronics package 104 to gather real-time audio feeds from external sources, which aids in environmental sound analysis. The ear-worn device 102 may utilize the inputs from the multiple microphones in the electronics package 104 to dynamically cancel noise, which may ensure clear voice capture even in noisy environmental conditions.

The ear-worn device 102 may also apply echo reduction techniques by processing variances in sound captured by the in-canal microphone 158 and the multiple microphones in the electronics package 104. Machine learning techniques may be utilized to suppress non-speech elements in the voice signal by analyzing patterns from both the in-canal microphone 158 and the multiple microphones in the electronics package 104. The ear-worn device 102 may thus continuously adapt to the user's voice and typical noise environments. Contextual sound patterns (for example, the recognition of train noises) may be used to adjust the sensitivity of voice recognition.

The system of the ear-worn device 102 may have numerous potential applications, including in smartphones and wearables, where enabling reliable hands-free operation may be an important feature, and in smart home systems, where the system may facilitate robust voice control capabilities in diverse environments. Other potential applications include in automotive systems, where the system may ensure precise detection of driver commands amidst road and vehicle noise, and in conference systems, where the system may facilitate capturing distinct voices in settings with multiple speakers.

There are numerous advantages provided by the system. One advantage is that the system, by virtue of the array of multiple microphones, may provide for excellent raw data capture, which is important for high-quality speech detection. Another advantage is that the noise cancellation and echo reduction may provide improved clarity and accuracy in voice recognition, which may reduce errors. The use of machine learning may allow for adaptive learning, which may enhance system performance over time by customizing the system to user-specific voice patterns and environments. Moreover, the use of both air-conducted and in-canal microphones may ensure robustness in voice detection across a variety of acoustic settings, which may enhance user satisfaction and system reliability.

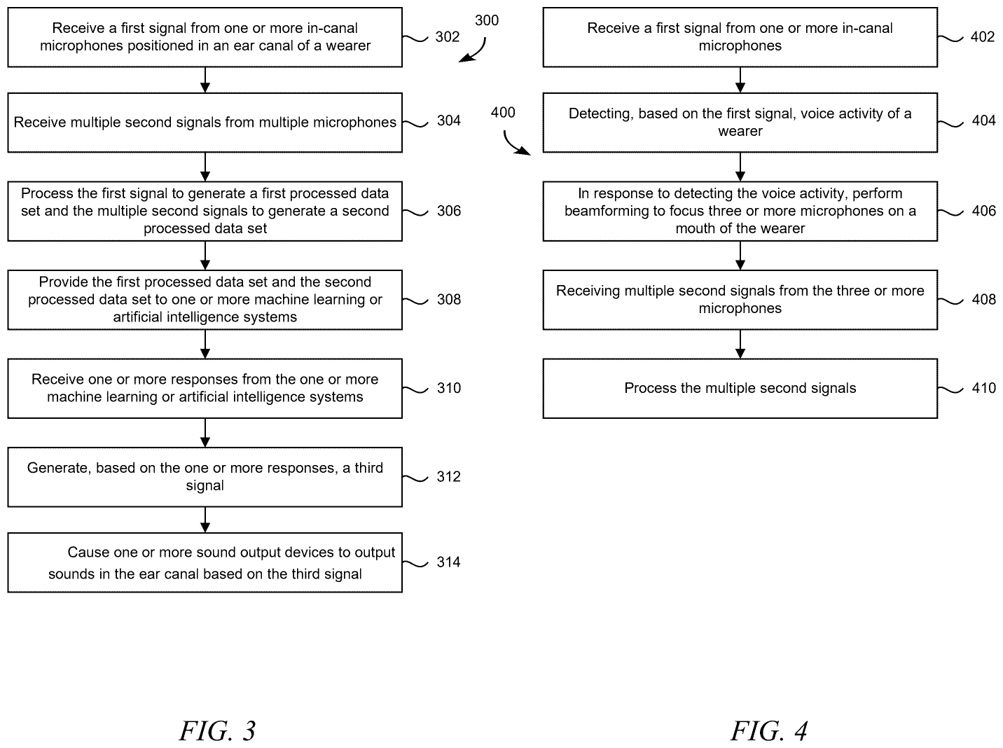

FIG. 3 is a flow diagram illustrating an example method 300 that some embodiments of aspects of the described technology may perform. The method 300 and the other methods herein are described as being at least partially performed by the ear-worn device 102, but it is to be understood that other systems or devices may perform some or all of the steps of the method 300 and the other methods herein. Furthermore, other devices, such as the wearable device 204, may perform some or all of the steps of the method 300 and the other methods herein, and other systems in the environment 200 may perform some of the steps.

The method may begin at step 302, where a first signal from one or more in-canal microphones positioned in an ear canal of a wearer is received. The first signal is generated from speech of the wearer (for example, a request by the wearer) captured by the one or more in-canal microphones (for example, the in-canal microphone 158). The one or more in-canal microphones are included in a first portion (for example, the acoustic package 108) of a device worn by the wearer (for example, the ear-worn device 102). The first portion is positioned at least partially in the ear canal and also includes one or more sound output devices configured to output sounds in the ear canal (for example, the driver 156 or the balanced armature 160).

At step 304, multiple second signals from the multiple microphones are received. The multiple microphones are included in a second portion (for example, the electronics package 104) of the device. The multiple second signals are generated from the speech of the wearer, such as the same speech captured by the one or more in-canal microphones. At step 306, the first signal is processed to generate a first processed data set and the multiple second signals are processed to generate a second processed data set. For example, the signals may be digitized, and features may be extracted from the digitized signals.

At step 308, the first processed data set and the second processed data set are provided to one or more machine learning or artificial intelligence systems. The first processed data set and the second processed data set may be compressed and encrypted prior to being provided to the one or more machine learning or artificial intelligence systems. In some embodiments, a compression algorithm that is tailored for sub-1 kHz speech is utilized to compress the first processed data set. At step 310 one or more responses (for example, responses to the wearer's request) are received from the one or more machine learning or artificial intelligence systems. At step 312, based on the one or more responses, a third signal (for example, an audio signal) is generated. At step 314, the one or more sound output devices (for example, the driver 156 or the balanced armature 160) are caused to output sounds in the ear canal based on the third signal.

Additional steps may be performed, such as receiving signals generated from external sounds captured by the multiple microphones, generating noise cancellation signals based on the external sound signals, and causing the one or more sound output devices to output sound based on the noise cancellation signals.

In some aspects, the techniques described herein relate to a method including: receiving a first signal from one or more in-canal microphones positioned in an ear canal of a wearer, the first signal generated from speech of the wearer captured by the one or more in-canal microphones, the one or more in-canal microphones included in a first portion of a device worn by the wearer, the first portion positioned at least partially in the ear canal, the first portion further including one or more sound output devices configured to output sounds in the ear canal; receiving multiple second signals from multiple microphones included in a second portion of the device, the multiple second signals generated from the speech of the wearer; processing the first signal to generate a first processed data set and the multiple second signals to generate a second processed data set; providing the first processed data set and the second processed data set to one or more machine learning or artificial intelligence systems; receiving one or more responses from the one or more machine learning or artificial intelligence systems; generating, based on the one or more responses, a third signal; and causing the one or more sound output devices to output sounds in the ear canal based on the third signal.

In some aspects, the techniques described herein relate to a method wherein the sounds are first sounds, and further including: receiving multiple fourth signals from the multiple microphones, the multiple fourth signals generated from external sounds; generating, based on the multiple fourth signals, multiple noise cancellation signals; and causing the one or more sound output devices to output second sounds based on the multiple noise cancellation signals.

In some aspects, the techniques described herein relate to a method wherein the sounds are first sounds, and further including: detecting second sounds output by the one or more sound output devices emanating from the ear canal; generating, based on the second sounds, a noise cancellation signal; and causing at least one sound output device to output third sounds based on the noise cancellation signal.

In some aspects, the techniques described herein relate to a method wherein providing the first processed data set to the one or more machine learning or artificial intelligence systems includes providing the first processed data set to at least one speech to text model configured for in-canal speech.

In some aspects, the techniques described herein relate to a method, further including modifying at least one foundation model using in-canal speech data to generate the at least one speech to text model configured for in-canal speech.

In some aspects, the techniques described herein relate to a method wherein providing the first processed data set and the second processed data set to the one or more machine learning or artificial intelligence systems includes: providing the first processed data set to multiple speech to text models configured for in-canal speech; and receiving multiple responses and multiple confidence scores from the multiple speech to text models, wherein generating, based on the one or more responses, the third signal includes generating, based on the multiple responses and the multiple confidence scores, the third signal.

In some aspects, the techniques described herein relate to a method wherein the device is a first device, the first device further includes one or more processors and wireless communication circuitry, the one or more machine learning or artificial intelligence systems include a first artificial intelligence agent, the one or more processors execute instructions for the first artificial intelligence agent, the one or more responses are one or more first responses, the sounds are first sounds, and further including: detecting that the first device is not coupled to a second device via the wireless communication circuitry; receiving a fourth signal from the one or more in-canal microphones; processing the fourth signal to generate third data; providing the third data to the first artificial intelligence agent; receiving one or more second responses from the first artificial intelligence agent; generating, based on the one or more second responses, a fifth signal; and causing the one or more sound output devices to output second sounds based on the fifth signal.

In some aspects, the techniques described herein relate to one or more non-transitory computer-readable media including executable instructions that when executed by one or more processors of a system cause the system to perform a method including: receiving a first signal from one or more in-canal microphones positioned in an ear canal of a wearer, the first signal generated from speech of the wearer captured by the one or more in-canal microphones, the one or more in-canal microphones included in a first portion of a device worn by the wearer, the first portion positioned at least partially in the ear canal, the first portion further including one or more sound output devices configured to output sounds in the ear canal; receiving multiple second signals from multiple microphones included in a second portion of the device, the multiple second signals generated from the speech of the wearer; processing the first signal to generate a first processed data set and the multiple second signals to generate a second processed data set; providing the first processed data set and the second processed data set to one or more machine learning or artificial intelligence systems; receiving one or more responses from the one or more machine learning or artificial intelligence systems; generating, based on the one or more responses, a third signal; and causing the one or more sound output devices to output sounds in the ear canal based on the third signal.

In some aspects, the techniques described herein relate to one or more non-transitory computer-readable media wherein the sounds are first sounds, and the method further includes: receiving multiple fourth signals from the multiple microphones, the multiple fourth signals generated from external sounds; generating, based on the multiple fourth signals, multiple noise cancellation signals; and causing the one or more sound output devices to output second sounds based on the multiple noise cancellation signals.

In some aspects, the techniques described herein relate to one or more non-transitory computer-readable media, and the method further includes: detecting second sounds output by the one or more sound output devices emanating from the ear canal; generating, based on the second sounds, a noise cancellation signal; and causing at least one sound output device to output third sounds based on the noise cancellation signal.

In some aspects, the techniques described herein relate to one or more non-transitory computer-readable media wherein providing the first processed data set to the one or more machine learning or artificial intelligence systems includes providing the first processed data set to at least one speech to text model configured for in-canal speech.

In some aspects, the techniques described herein relate to one or more non-transitory computer-readable media, the method further including modifying at least one foundation model using in-canal speech data to generate the at least one speech to text model configured for in-canal speech.

In some aspects, the techniques described herein relate to one or more non-transitory computer-readable media wherein providing the first processed data set and the second processed data set to the one or more machine learning or artificial intelligence systems includes: providing the first processed data set to multiple speech to text models configured for in-canal speech; and receiving multiple responses and multiple confidence scores from the multiple speech to text models, wherein generating, based on the one or more responses, the third signal includes generating, based on the multiple responses and the multiple confidence scores, the third signal.

In some aspects, the techniques described herein relate to one or more non-transitory computer-readable media wherein the device is a first device, the first device further includes one or more processors and wireless communication circuitry, the one or more machine learning or artificial intelligence systems include a first artificial intelligence agent, the one or more processors execute instructions for the first artificial intelligence agent, the one or more responses are one or more first responses, the sounds are first sounds, and further including: detecting that the first device is not coupled to a second device via the wireless communication circuitry; receiving a fourth signal from the one or more in-canal microphones; processing the fourth signal to generate third data; providing the third data to the first artificial intelligence agent; receiving one or more second responses from the first artificial intelligence agent; generating, based on the one or more second responses, a fifth signal; and causing the one or more sound output devices to output second sounds based on the fifth signal.

In some aspects, the techniques described herein relate to a device including: a first portion configured to be positioned at least partially in an ear canal of a wearer, the first portion including: one or more in-canal microphones configured to capture sounds or vibrations in the ear canal; and one or more sound output devices configured to output sounds in the ear canal; a second portion including multiple microphones configured to capture external sounds; one or more processors; and one or more memories storing instructions that upon execution by the one or more processors cause the device to perform a method, the method including: receiving a first signal from the one or more in-canal microphones, the first signal generated from speech of the wearer captured by the one or more in-canal microphones, receiving multiple second signals from the multiple microphones, the multiple second signals generated from the speech of the wearer; processing the first signal to generate a first processed data set and the multiple second signals to generate a second processed data set; providing the first processed data set and the second processed data set to one or more machine learning or artificial intelligence systems; receiving one or more responses from the one or more machine learning or artificial intelligence systems; generating, based on the one or more responses, a third signal; and causing the one or more sound output devices to output sounds in the ear canal based on the third signal.

### Noise Cancellation or Mitigation for In-Ear Canal Sound

Conventional in-ear designs, such as generic earbuds or noise-canceling headphones, help reduce external noise, but generally do not comprehensively contain sound output in an ear canal. As a result, sound can still leak out to the surrounding environment, which may risk the privacy of the wearer. Additionally, one-size-fits-all earbud designs often result in imperfect sealing, leading to suboptimal noise isolation and potential discomfort. Active noise cancellation (ANC) in standard earbuds focuses on blocking incoming noise. Users often require confidentiality when interacting with voice assistants in public spaces, at work, or during travel. In conventional in-ear designs, sound may inadvertently emanate from the ear canal, thus impairing confidentiality.

Embodiments of the described technology provide technical solutions to these technical problems. An example embodiment is the ear-worn device 102 of FIG. 1A. In some embodiments, the ear-worn device 102 may utilize active noise cancellation directed outward to reduce or minimize such sound, thereby ensuring that the in-canal sound is audible only to the wearer. The ear-worn device 102 may use sensors, such as the multiple microphones or other sensors, to detect sounds output by the one or more sound output devices that are emanating from the ear canal. The ear-worn device 102 may generate, based on the sounds, a noise cancellation signal and cause at least one sound output device to output sounds based on the noise cancellation signal. The ear-worn device 102 may also continuously measure ambient sound levels and automatically raise or lower the volume to maintain clarity for the user while reducing or minimizing external audibility. The ear-worn device 102 may also provide passive noise mitigation through the acoustically sealed fit provided by the ear interface 106.

An example scenario where the ear-worn device 102 may be utilized involves a user in a shared office who needs to discreetly listen to voice assistant notifications or dictate messages. The outward-directed ANC suppresses any unintended leaks, preserving privacy for the user and a quiet environment for coworkers.

Potential applications where the ear-worn device 102 may be utilized include workplace settings, such as in an open-plan office, where it may be beneficial to discreetly access sensitive voice assistant data, and healthcare or defense settings where high levels of acoustic security may be required. Other potential use cases for the ear-worn device 102 include in commuting and public spaces, as the ear-worn device 102 may allow users to engage with artificial intelligence agents without disturbing others or revealing personal information, and in military and government settings, where confidentiality is a necessity, and where the ear-worn device 102 may facilitate confidential personal audio feeds.

Advantages of the ear-worn device 102 include that the ear-worn device 102 may provide for enhanced privacy and confidentiality, as the outward-directed ANC may reduce or prevent unwanted sound leakage. The ear-worn device 102 may allow for adaptive noise control by measuring environmental noise in real time, thereby ensuring clarity for the user while remaining unobtrusive to others. Another advantage is that the technology may be integrated into earbud form factors, making it compact, portable, and user-friendly for daily use. By reducing external noise leakage, the technology fosters a quiet environment, benefiting both the user and nearby individuals.

### Natural Language Processing Model Adaptation for In-Canal Voice Capture

Conventional natural language process (NLP) systems are typically trained on broad-range, open-air recordings, such as datasets from smartphone microphones, conference recordings, or headset audio. These models do not fully capture the muffled or bone-conducted speech characteristics common in sound captured by in-canal microphones. As a result, the word error rate (WER) rises, and natural language understanding (NLU) performance diminishes when in-canal recordings deviate significantly from standard training data. Some voice assistant platforms may adjust for environmental or dialect nuances, but they do not incorporate specialized frequency corrections or confidence scoring relevant to in-canal acoustic profiles. Occluded ear captures highlight low-to-mid frequency ranges and often distort higher-frequency speech components, impairing model accuracy.

Embodiments of the described technology provide technical solutions to these technical problems. A system according to the described technology leverages transfer learning approaches to fine-tune existing speech and NLP models with in-canal-specific data. By employing data augmentation techniques, such as synthetically simulating resonances and muffled acoustic patterns, the system learns to account for shifts caused by ear occlusion. A frequency-specific confidence scoring mechanism further refines output based on real-time acoustic reliability (for example, if certain consonants are consistently misheard). Moreover, specialized data collection from actual in-canal devices captures realistic samples, ensuring a robust adaptation pipeline

The system may utilize speech to text models configured for in-canal speech in various embodiments. Such a speech to text model may be configured by fine-tuning or modifying a foundation model by modifying parameters to account for occluded ear acoustics. Moreover, in-canal data may be incorporated in an acoustic model, a language model, or both. Other techniques that may be used include augmenting existing data to simulate in-canal microphone characteristics by applying filters and convolutions that replicate resonance and muffling or by merging realistic background noise or bone-conducted input patterns into existing data. Both approaches may expand the diversity of training data. Other techniques may include modifying phoneme recognition probabilities by assigning higher or lower confidence to recognized phonemes based on known in-canal misrecognition tendencies and utilizing real-time feedback from the user, which would allow for re-checks or re-queries when certain frequency bands are consistently unreliable. Specialized datasets covering a representative range of occluded voices, speaking styles, and ambient conditions may be used, as well as datasets in different languages to ensure wide linguistic variety.

An example use of the technology involves a user wearing in-canal earbuds that connect to a voice assistant for dictating emails. Traditional NLP models might struggle to parse fast spoken or mid-syllable consonants muffled by occlusion. With this system, the user seamlessly dictates text, and the model-augmented assistant accurately understands context and meaning, even in noisy locations or while the user speaks at a low volume.

A potential application of the system is in earbuds and hearables to enhance everyday command-and-control for artificial intelligence assistants in occluded ear designs. Another potential application is in the enterprise and industrial context, where the system may improve voice-based instruction systems in environments where workers use sealed hearing protection. The system may also be utilized in medical and healthcare settings to aid medical staff wearing noise-isolating earpieces for privacy and safety, and in military and security settings to facilitate accurate speech recognition under helmet or ear-sealed conditions.

Advantages of the technology include improved recognition accuracy: by adapting proven NLP solutions to occluded environments, word error rates can be reduced. The system also allows for more efficient development, by leveraging existing models (transfer learning) instead of building from scratch. Other advantages include context-aware processing: frequency-specific confidence scoring allows dynamic error correction; a flexible implementation that may be integrated into various ear-worn devices or hearing aids; and a scalable methodology, as augmentation and data collection can be expanded to new languages, user populations, or device types.

### Utilizing Multiple Speech to Text Models in Parallel

Voice recognition systems typically use a single speech to text engine or occasionally switch among multiple speech to text engines manually or via hard-coded domain triggers. Variance in model performance is common: some speech to text engines excel with non-native accents, others handle domain-specific vocabulary or noisy surroundings better. Moreover, a single speech to text engine may degrade in performance if it is not well-adapted to the in-canal microphone environment, which can produce distinctive audio profiles due to occlusion effects and body-conducted sounds.

The described technology provides technical solutions to these technical problems. A system according to the technology implements an architecture in which multiple specialized speech to text models run simultaneously, each receiving the same audio stream (either in-canal speech, external microphone speech, or a combination of the two) but optimized for different user speech traits, domain context, or environment conditions. The system may transmit real-time audio input to multiple speech to text models (for example, a model specialized in noisy environments, another in medical vocabulary, yet another in standard conversation). Depending on device constraints, the system may run these models locally or offload some parallel processing to one or more artificial intelligence agents.

Each speech to text engine returns a confidence measure for its transcription (for example, a per-word or per-phrase probability). The system may reweigh confidences if it knows, for instance, that the user is discussing a certain domain or if the user's accent aligns with a particular model. The system may choose the transcription path with the highest overall confidence or optionally merge segments if the confidence distribution indicates certain engines did better on specific parts (a “composite” approach). Once the best transcription is selected, it can be provided to a language model or for intent parsing. If partial transcripts are streaming in, the system can perform ongoing confidence checks, improving partial transcripts on the fly to minimize user wait times.

Over time, the system learns which speech to text engines excel for a given user's accent or usage scenario and may adjust priority or weighting accordingly. If the user starts discussing domain-specific topics (for example, medical, automotive, music playlists), the system selectively favors the model known to handle that lexicon more accurately.

The system may account for an in-canal microphone's unique acoustic profile, ensuring each speech to text path is trained or pre-processed to handle muffled or body-transmitted vibrations. Each model may receive audio processed by different noise-cancellation approaches, with the system selecting the pipeline output that yields the clearest speech recognition.

The following scenario illustrates a use of the system: A user wearing custom in-canal earbuds in a crowded, noisy coffee shop tries to place a voice-enabled coffee order and discuss meeting details using specialized terms. The system runs three speech to text models: Model A tuned for noisy environments, Model B for standard everyday conversation, and Model C specialized in calendar/schedule domain speech.

The user says, “Hey, book a staff meeting for next Tuesday at 2 PM, then order me a latte.” Each model produces a real-time transcript with confidence scores. The system identifies Model C's transcript for the meeting portion as highest confidence, but Model A outperforms for the ordering portion with coffee shop noise. The system merges or chooses whichever approach yields the best final output for each segment. The system routes the “staff meeting” request to a calendar agent and “order me a latte” to a coffee agent. As a result, the user's commands are accurately recognized and executed, despite noise and domain-specific language.

Potential applications include recognizing mixed-domain or mixed-language speech. Advantages of the technology include improved recognition accuracy by utilizing results and confidence scores from multiple models without undue latency.

### Agent Conversation Continuity During Connectivity Interruptions

Cloud-based artificial intelligence agents often rely on constant internet access to interpret commands and deliver responses. If connectivity drops, conventional assistants frequently fail, losing any ongoing conversation context. Existing fallback mechanisms typically rely on a complete offline model or degrade to rudimentary local mode that cannot store or process queued commands properly. Users in remote, mobile, or otherwise connectivity-limited scenarios cannot afford conversation breakdowns with their artificial intelligence assistant. Moreover, in-canal microphones present additional challenges due to the unique frequency profile (enhanced bone conduction in sub-1 kHz ranges) that may differ from typical microphone design assumptions.

The described technology provides technical solutions to these technical problems. A system according to the technology may utilize local processing tuned for in-canal audio input, with command queuing and seamless handoff to maintain continuity. The system may optimize for the sub-1 kHz frequency that is typical of bone-conducted or occluded speech. The system may utilize an artificial intelligence agent that can be run locally.

In the event of a network interruption, the system may hold parsed commands until network availability is detected, and may notify the user once queued instructions are successfully processed. The system may dynamically route commands to the local engine or the cloud back-end without interrupting the conversation flow and ensure both local and remote systems synchronize conversation state when connectivity returns.

In some embodiments, the system may offer subtle audio or haptic cues when switching between offline (local) and online (cloud) modes. This allows the user to keep engaging naturally with the artificial intelligence agent while staying informed about system status.

The system may be utilized in outdoors and adventure settings, for example, to ensure hikers, campers, or travelers maintain artificial intelligence support in limited-signal zones. The system may also be utilized in rural and developing areas to offer robust agent functionality where broadband connections are sporadic. The system may also be used in industrial and enterprise settings to help workers in large facilities with intermittent wireless connections remain productive, and in emergency and military environments, where the system may maintain critical voice-based systems when communications are compromised.

Advantages of the system include that the system provides for resilient communication by persisting the conversation flow with the artificial intelligence assistant despite poor or lost connectivity. The system also provides efficient local processing that is tailored for in-canal microphones, which may improve recognition accuracy without heavy dependency on remote systems. The system is also user-friendly in that command queueing and transparent handoffs minimize frustration, letting the user focus on tasks rather than network status. The system may also have limited hardware impact, as local artificial intelligence models and efficient voice capture are tailored to the power constraints of typical earbuds/hearables. The system may also be adapted for commercial wearables or specialized devices across multiple industries.

### Dual-Channel In-Canal and Multiple Microphone Array for Privacy-Protected Voice Activity Detection

Traditional voice interfaces rely on either a single external microphone (or two microphones) to capture speech or an in-canal microphone for noise insulation and privacy. External microphones do not guarantee privacy, because external microphones can still pick up ambient sound from other speakers or unwanted acoustic interference. On the other hand, an in-canal microphone is naturally more private, as it may be acoustically sealed in the ear canal, but it may suffer from limited fidelity or have difficulty capturing a robust full-spectrum speech signal for advanced processing. Existing solutions do not adequately combine these two approaches to exploit the strengths of both: increased performance on the exterior and robust voice activity detection from an in-canal microphone.

The described technology combines in-canal privacy with beamforming by an array of microphones. The in-canal microphone may be included inside a custom in-ear monitor (IEM) or other device that isolates the ear canal with sound-absorbing materials, yielding a highly private reference signal containing the user's speech. There may be three or more microphones around the ear's exterior (for example, integrated into an earbud housing) that perform beamforming to focus on the user's mouth. This produces a high-fidelity speech capture but may still pick up loud external noises.

The in-canal microphone, being mostly or entirely isolated from external noise, provides reliable voice activity cues even in loud environments. Its signal is used as a gate to determine if the user is actively speaking. When the in-canal microphone does not detect user voice, the external array's captured data is either not used, or remains idle, preventing unintentional listening or triggers from other sound sources.

During speaking episodes (as gated by the in-canal microphone), the system activates or unmutes the beamformed signal from the exterior array. This yields a full-spectrum user voice input that may be utilized for speech recognition or telephony. Beamforming algorithms help ignore off-axis signals, reducing background chatter or random shouts, although some external sound may still be recognized if loud enough or from a near field.

If the in-canal microphone does not detect user speech, the external array remains in a low-power or non-recording state (or heavily attenuated). Only upon confident voice activity detection does the system process and transmit the user's external microphone signal. The system allows for optional listen-through or transparency modes where the exterior array can intentionally capture external sound with user consent, but only after explicit enabling. By pairing an isolated in-canal microphone for voice gating with a directional exterior array for high-quality speech capture, the system delivers privacy safeguards (no open listening unless the user is speaking) and noise-robust beamformed audio.

An example use case is the following: a user is working in a bustling coffee shop. When the user speaks, the in-canal microphone reliably detects voice activity, activating the external beamforming array. The array hones in on the user's mouth, capturing crisp speech for a voice call or artificial intelligence assistant, despite surrounding chatter. If someone shouts in the distance, the in-canal microphone does not detect user speech, so the system remains effectively off for external capture. This ensures no accidental triggers from external noises and protects the user's privacy, as well as the privacy of other individuals who may be near the user, by not listening when the user is silent.

FIG. 4 is a flow diagram illustrating an example method 400 that some embodiments of aspects of the described technology may perform. The method may begin at step 402, where a first signal from one or more in-canal microphones is received. The one or more in-canal microphones are included in a first portion of a device that is positioned at least partially in an ear canal of a wearer. The one or more in-canal microphones are configured to capture sounds or vibrations in the ear canal.

At step 404, based on the first signal, voice activity of the wearer is detected. At step 406, in response to detecting the voice activity, beamforming is performed to focus three or more microphones on a mouth of the wearer. The three or more microphones are included in a second portion of the device and are configured to capture external sounds. At step 408, multiple second signals from the three or more microphones are received, and at step 410, the multiple second signals are processed.

Additional steps may include providing the multiple second signals to an artificial intelligence agent, receiving a response from the artificial intelligence agent, generating, based on the response, a third signal, and outputting, by one or more sound output devices included in the first portion of the device, the third signal.

In some aspects, the techniques described herein relate to a device including: a first portion configured to be positioned at least partially in an ear canal of a wearer, the first portion including one or more in-canal microphones configured to capture sounds or vibrations in the ear canal; a second portion including three or more microphones configured to capture external sounds; and one or more memories storing instructions that upon execution cause the device to perform a method, the method including: receiving a first signal from the one or more in-canal microphones; detecting, based on the first signal, voice activity of the wearer; in response to detecting the voice activity, performing beamforming to focus the three or more microphones on a mouth of the wearer; receiving multiple second signals from the three or more microphones; and processing the multiple second signals.

In some aspects, the techniques described herein relate to a device wherein the three or more microphones are configured to be in an active capture mode in response to detecting the voice activity and the three or more microphones are configured to be in a low-power mode or an idle capture mode prior to detecting the voice activity.

In some aspects, the techniques described herein relate to a device wherein receiving the multiple second signals is in response to detecting the voice activity and the method further includes providing the multiple second signals to a computing device.

In some aspects, the techniques described herein relate to a device wherein receiving the multiple second signals occurs prior to detecting the voice activity and the method further includes discarding at least some of the multiple second signals.

In some aspects, the techniques described herein relate to a device wherein the first portion further includes one or more sound output devices configured to output sounds in the ear canal, and the method further includes: providing the multiple second signals to an artificial intelligence agent; receiving a response from the artificial intelligence agent; generating, based on the response, a third signal; and outputting, by the one or more sound output devices, the third signal.

In some aspects, the techniques described herein relate to a device, wherein the method further includes: receiving a fourth signal from the one or more in-canal microphones; identifying portions of the fourth signal attributable to bone-conducted speech of the wearer; generating, based on the identified portions of the fourth signal, a fifth signal to reduce or attenuate the bone-conducted speech of the wearer; and outputting, by the one or more sound output devices, the fifth signal, thereby reducing or attenuating the bone-conducted speech of the wearer in the ear canal of the wearer.

In some aspects, the techniques described herein relate to a method including: receiving a first signal from one or more in-canal microphones included in a first portion of a device, the first portion positioned at least partially in an ear canal of a wearer, the one or more in-canal microphones configured to capture sounds or vibrations in the ear canal; detecting, based on the first signal, voice activity of the wearer; in response to detecting the voice activity, performing beamforming to focus three or more microphones on a mouth of the wearer, the three or more microphones included in a second portion of the device, the three or more microphones configured to capture external sounds; receiving multiple second signals from the three or more microphones; and processing the multiple second signals.

In some aspects, the techniques described herein relate to a method, further including: maintaining the three or more microphones in a low-power mode or an idle capture mode prior to detecting the voice activity; and in response to detecting the voice activity, transitioning the three or more microphones to an active capture mode.

In some aspects, the techniques described herein relate to a method wherein receiving the multiple second signals is in response to detecting the voice activity, and further including providing the multiple second signals to a computing device.

In some aspects, the techniques described herein relate to a method wherein receiving the multiple second signals occurs prior to detecting the voice activity and the method further includes discarding at least some of the multiple second signals.

In some aspects, the techniques described herein relate to a method wherein the first portion further includes one or more sound output devices, and further including: providing the multiple second signals to an artificial intelligence agent; receiving a response from the artificial intelligence agent; generating, based on the response, a third signal; and outputting, by the one or more sound output devices, the third signal.

In some aspects, the techniques described herein relate to a method, further including: receiving a fourth signal from the one or more in-canal microphones; identifying portions of the fourth signal attributable to bone-conducted speech of the wearer; generating, based on the identified portions of the fourth signal, a fifth signal to reduce or attenuate the bone-conducted speech of the wearer; and outputting, by the one or more sound output devices, the fifth signal, thereby reducing or attenuating the bone-conducted speech of the wearer in the ear canal of the wearer.

In some aspects, the techniques described herein relate to one or more non-transitory computer-readable media including executable instructions that when executed by one or more processors of a system cause the system to perform a method including: receiving a first signal from one or more in-canal microphones included in a first portion of a device, the first portion positioned at least partially in an ear canal of a wearer, the one or more in-canal microphones configured to capture sounds or vibrations in the ear canal; detecting, based on the first signal, voice activity of the wearer; in response to detecting the voice activity, performing beamforming to focus three or more microphones on a mouth of the wearer, the three or more microphones included in a second portion of the device, the three or more microphones configured to capture external sounds; receiving multiple second signals from the three or more microphones; and processing the multiple second signals.

In some aspects, the techniques described herein relate to one or more non-transitory computer-readable media, the method further including: maintaining the three or more microphones in a low-power mode or an idle capture mode prior to detecting the voice activity; and in response to detecting the voice activity, transitioning the three or more microphones to an active capture mode.

In some aspects, the techniques described herein relate to one or more non-transitory computer-readable media wherein receiving the multiple second signals is in response to detecting the voice activity, and further including providing the multiple second signals to a computing device.

In some aspects, the techniques described herein relate to one or more non-transitory computer-readable media wherein receiving the multiple second signals occurs prior to detecting the voice activity and the method further includes discarding at least some of the multiple second signals.

In some aspects, the techniques described herein relate to one or more non-transitory computer-readable media wherein the first portion further includes one or more sound output devices, and the method further includes: providing the multiple second signals to an artificial intelligence agent; receiving a response from the artificial intelligence agent; generating, based on the response, a third signal; and outputting, by the one or more sound output devices, the third signal.

In some aspects, the techniques described herein relate to one or more non-transitory computer-readable media wherein the method further includes: receiving a fourth signal from the one or more in-canal microphones; identifying portions of the fourth signal attributable to bone-conducted speech of the wearer; generating, based on the identified portions of the fourth signal, a fifth signal to reduce or attenuate the bone-conducted speech of the wearer; and outputting, by the one or more sound output devices, the fifth signal, thereby reducing or attenuating the bone-conducted speech of the wearer in the ear canal of the wearer.

### Self-Voice Cancellation or Attenuation

In-canal earbuds and other ear-worn devices often occlude the ear canal, causing the user's own voice (transmitted via bone conduction) to mask or overpower external sounds. Traditional transparency or ambient modes typically only capture external audio through microphones and feed it back into the user's ears. While this improves awareness of surroundings, it does not adequately handle the occlusion effect of the user's self-voice, which can still dominate. Moreover, many voice-enabled devices prioritize capturing speech for artificial intelligence agents without optimizing the user's experience of environmental sounds. Consequently, critical external cues, such as oncoming vehicles or important announcements, can be missed when the user is speaking.

For example, to ensure safety and situational awareness, it may be important that users can hear their surroundings while speaking, such as to an artificial intelligence agent. The described technology provides technical solutions to these technical problems. In some embodiments, the technology may apply a real-time separation filter that identifies and subtracts bone-conducted self-voice from the overall sound mix. A predictive model of the user's speech may help the filter anticipate and cancel or reduce the user's own voice frequencies. The device may operate in a transparent mode that maintains a clear channel for the artificial intelligence agent while simultaneously enhancing external audio cues. Context-aware balancing may adjust how aggressively self-voice is canceled, which may ensure that the user maintains some sense of his or her own speech (to avoid disorienting experiences) but not to the extent that it drowns out important ambient sounds.

In the system, in-canal microphones capture the overall audio signal, while additional sensors measure bone conduction. The system applies subtraction algorithms to isolate self-voice frequencies. The system continuously adjusts parameters to handle variations in user voice volume or pitch.

The system may use predictive modeling of a user's speech by learning unique features of the user's vocal signature and articulation habits. The system may create a short predictive window, letting the system begin self-voice attenuation as soon as speech is detected. The system may enhance external sounds by simultaneously monitoring ambient sounds and injecting them into the user's ear at a comfortable level for the user. The system may not remove user speech entirely but instead scale it down to prevent disorientation, maintaining a natural sense of vocal feedback. The system may also balance self-voice and environmental sounds based on the context. For example, the system may increase external sound gain when in busy or hazardous environments (for example, crossing a street). The system may also temporarily lower the attenuation of self-voice if the user needs clear feedback on their speaking volume in quiet areas (for example, a library).

An example use case is as follows: a user is jogging on a city street wearing in-canal earbuds. The user engages with a voice assistant, asking for directions or controlling music. Normally, the user's own speaking voice would be amplified inside their head, making it difficult to hear approaching bicycles or traffic signals. With self-voice cancellation, the device filters out the user's own voice while maintaining a safe level of surrounding sound. The user benefits from unobstructed awareness and can continue talking to the assistant without losing track of the urban environment.

Potential applications of the system include for urban commuters and joggers who need to hear traffic, alerts, and general surroundings while engaging in conversation with an artificial intelligence agent and in workplace scenarios for employees operating machinery or collaborating in open spaces. The system can allow such employees to hear coworkers while using voice commands for devices. Other potential applications include military and public safety uses, in which the system may enable personnel to maintain high situational awareness while issuing voice-based directives, and in conference and lecture environments, in which the system may allow users to discreetly communicate with artificial intelligence agents without fully isolating themselves from a presenter or group discussion.

Advantages of the technology include enhanced safety and awareness, as the user perceives crucial environmental audio cues even while speaking to the assistant. Another advantage is that the subtle attenuation of the system allows for enough self-voice feedback to be retained to prevent speech disorientation. Another advantage is reduced occlusion fatigue, as the booming or muffled quality of one's own voice in in-canal devices is reduced or minimized. The system is adaptive, in that the use of predictive modeling and context awareness allows the system to adapt to changes in the user's environment and speaking style. The system also allows for an improved user experience, as the system may provide a seamless interaction with artificial intelligence agents without sacrificing ambient perception.

### Dual-Mode Agent Interaction System With Seamless Microphone Switching or Blending

Most earbuds, headsets, or smart devices rely on a single primary microphone, either a standard external microphone to capture ambient speech or an in-canal microphone designed to reduce noise through occlusion and bone conduction. However, no single solution may be optimal for all conditions. In quiet environments, an external microphone may capture nuanced speech more naturally, while high-noise settings usually benefit from an in-canal microphone's inherent noise isolation. Existing products seldom incorporate a real-time switching mechanism that intelligently selects (or blends) audio streams from both sources.

The described technology provides technical solutions to these technical problems. Users often move through environments with rapidly changing noise levels: a quiet office hallway one moment, a bustling street the next. A system according to the described technology may continuously analyze external noise via external microphones and monitor speech clarity from the in-canal microphone. When the system detects that background noise exceeds a threshold (or that the user's speech is overshadowed by ambient sounds), the system may switch to the in-canal microphone. Conversely, if the environment is quieter, the system may revert to using the external microphone alone or in combination with the in-canal microphone for a more natural-sounding conversation. A blended processing pipeline further refines voice quality by dynamically weighting the two audio inputs. Over time, user preference learning adjusts these thresholds or weighting factors based on individual speaking habits and feedback, minimizing manual intervention.

The system may continuously monitor ambient noise and automatically switch or blend input from external and in-canal microphones, thereby facilitating voice capture quality. The system may measure ambient sounds in real time, identifying threshold crossings for noise intensity. When ambient decibels (dB) surpasses a preset threshold, the system may seamlessly transition to the in-canal microphone to leverage noise isolation. The smooth handoff avoids abrupt audio loss or latency, ensuring continuous conversation with the artificial intelligence agent. In some embodiments, the system incorporates location and time-based clues to anticipate changes in noise levels (for example, rush-hour traffic).

The system may combine signals from external and in-canal mics, selecting the most intelligible phonemes from each source. The system may adjust weighting in real time (for example, 30% external, 70% in-canal) depending on detected speech clarity. The system may learn user preferences over time by remembering a user's acceptance or rejection of certain switching decisions, thereby allowing the system to refine crossing thresholds automatically. The system may also learn the user's typical environments (home, office, gym) and preemptively configure the microphone priority, meaning that the system may prioritize the in-canal microphone over the external microphones, or vice-versa.

An example use of the system involves a user strolling through a city, occasionally passing construction zones. While walking in moderate noise, the device defaults to external microphone mode for a more natural vocal capture. Approaching the loud construction site, the system detects elevated noise levels and instantly switches to the in-canal microphone to maintain clear speech pickup. Once the user moves away from the noise, the system may seamlessly shift back or blend the inputs. The user experiences no disruption, enjoying continuous, high-quality artificial intelligence assistant interaction regardless of location.

Potential applications of the system include consumer earbuds and headsets to enhance everyday voice assistant usage in various environments, from quiet offices to busy city streets and in enterprise and industrial headsets to protect worker productivity in factories or construction sites where noise levels fluctuate. Another potential application is in military and security contexts, as the system may be utilized to support mission-critical communication where external or in-canal modes can be toggled rapidly, and in healthcare environments, such as to allow medical staff to swiftly adapt between silent wards and more bustling areas with minimal user action.

Advantages of the technology include adaptive audio quality, as the system may maintain clear speech recognition in both low-noise and high-noise conditions, and hands-free operation, as the automatic switching may free users from manual microphone mode adjustments. Another advantage involves user-centric learning: the system may continuously improve by incorporating personal usage patterns and feedback. Yet another advantage involves seamless transition between microphones: no conversation dropouts or reconfigurations may be necessary to switch microphones when ambient noise changes suddenly.

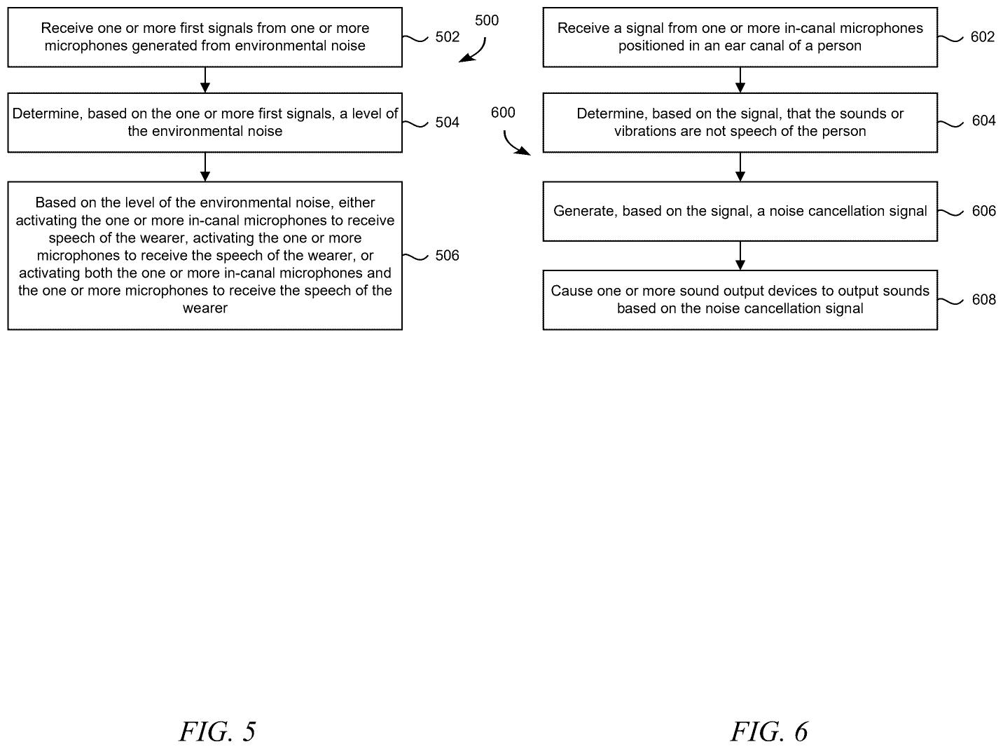

FIG. 5 is a flow diagram illustrating an example method 500 that some embodiments of aspects of the described technology may perform. The method 500 may begin at step 502 where one or more first signals that are generated from environmental noise captured by one or more microphones are received. The one or more microphones are included in a second portion of a device and are configured to capture external sounds. The device also includes a first portion configured to be at least partially inserted into an ear canal of a wearer. The first portion includes one or more in-canal microphones configured to capture sounds or vibrations in the ear canal.

At step 504, based on the one or more first signals, a level of the environmental noise is determined. At step 506, based on the level of the environmental noise, either the one or more in-canal microphones are activated to receive speech of the wearer, the one or more microphones are activated to receive the speech of the wearer, or both the one or more in-canal microphones and the one or more microphones are activated to receive the speech of the wearer.

Additional steps may include determining a first clarity of the speech received from the one or more in-canal microphones, determining a second clarity of the speech received from the one or more microphones, and adjusting, based on the first clarity and the second clarity, a first weighting of the speech received from the one or more in-canal microphones and a second weighting of the speech received from the one or more microphones.

In some aspects, the techniques described herein relate to a device including: a first portion configured to be positioned at least partially in an ear canal of a wearer, the first portion including one or more in-canal microphones configured to capture sounds or vibrations in the ear canal; a second portion including one or more microphones configured to capture external sounds; one or more processors; and one or more memories storing instructions that upon execution by the one or more processors cause the device to perform a method, the method including: receiving one or more first signals from the one or more microphones, the one or more first signals generated from environmental noise; determining, based on the one or more first signals, a level of the environmental noise; and based on the level of the environmental noise, either: activating the one or more in-canal microphones to receive speech of the wearer; activating the one or more microphones to receive the speech of the wearer; or activating both the one or more in-canal microphones and the one or more microphones to receive the speech of the wearer.

In some aspects, the techniques described herein relate to a device wherein the method further includes if both the one or more in-canal microphones and the one or more microphones are activated to receive the speech of the wearer: determining a first clarity of the speech received from the one or more in-canal microphones; determining a second clarity of the speech received from the one or more microphones; and adjusting, based on the first clarity and the second clarity, a first weighting of the speech received from the one or more in-canal microphones and a second weighting of the speech received from the one or more microphones.

In some aspects, the techniques described herein relate to a device wherein the method further includes: receiving one or more of a location of the device, a time, or a schedule of the wearer of the device; and prioritizing, based on one or more of the location, the time, or the schedule, either the one or more in-canal microphones or the one or more microphones to receive the speech of the wearer.

In some aspects, the techniques described herein relate to a device wherein the method further includes if the one or more in-canal microphones is activated to receive the speech of the wearer: receiving a second signal from the one or more in-canal microphones, the second signal generated from the speech of the wearer; determining, based on the second signal, an intensity of the speech; and based on the intensity of the speech, either: alerting the wearer to reduce the intensity of the speech; or alerting the wearer to increase the intensity of the speech.

In some aspects, the techniques described herein relate to a device wherein the device further includes a haptic feedback device and one or more sound output devices and alerting the wearer includes either providing a haptic alert using the haptic feedback device or a sound alert using the one or more sound output devices.

In some aspects, the techniques described herein relate to a device wherein the device further includes wireless communication circuitry that enables a wireless connection with a second device, and alerting the wearer includes instructing the second device using the wireless connection to provide an alert via the second device.

In some aspects, the techniques described herein relate to a device wherein the first portion further includes one or more sound output devices that is physically segregated from the one or more in-canal microphones and one or more dampening materials positioned between the one or more sound output devices and the one or more in-canal microphones.

In some aspects, the techniques described herein relate to a device wherein the second portion further includes a feedforward microphone, and the method further includes if the one or more microphones are activated to receive the speech of the wearer: performing beamforming to focus the one or more microphones on a mouth of the wearer; receiving a second signal from the one or more microphones, the second signal generated from the speech of the wearer; receiving a third signal from the feedforward microphone, the third signal generated from the environmental noise; generating, based on the third signal, a noise cancellation signal; and causing the one or more sound output devices to output sound based on the noise cancellation signal.

In some aspects, the techniques described herein relate to a method including: receiving one or more first signals from one or more microphones generated from environmental noise, the one or more microphones included in a second portion included in a device and configured to capture external sounds, the device further including a first portion configured to be at least partially inserted into an ear canal of a wearer, the first portion including one or more in-canal microphones configured to capture sounds or vibrations in the ear canal; determining, based on the one or more first signals, a level of the environmental noise; and based on the level of the environmental noise, either: activating the one or more in-canal microphones to receive speech of the wearer; activating the one or more microphones to receive the speech of the wearer; or activating both the one or more in-canal microphones and the one or more microphones to receive the speech of the wearer.

In some aspects, the techniques described herein relate to a method, further including if both the one or more in-canal microphones and the one or more microphones are activated to receive the speech of the wearer: determining a first clarity of the speech received from the one or more in-canal microphones; determining a second clarity of the speech received from the one or more microphones; and adjusting, based on the first clarity and the second clarity, a first weighting of the speech received from the one or more in-canal microphones and a second weighting of the speech received from the one or more microphones.

In some aspects, the techniques described herein relate to a method, further including: receiving one or more of a location of the device, a time, or a schedule of the wearer of the device; and prioritizing, based on one or more of the location, the time, or the schedule, either the one or more in-canal microphones or the one or more microphones to receive the speech of the wearer.

In some aspects, the techniques described herein relate to a method, further including if the one or more in-canal microphones is activated to receive the speech of the wearer: receiving a second signal from the one or more in-canal microphones, the second signal generated from the speech of the wearer; determining, based on the second signal, an intensity of the speech; and based on the intensity of the speech, either: alerting the wearer to reduce the intensity of the speech; or alerting the wearer to increase the intensity of the speech.

In some aspects, the techniques described herein relate to a method wherein the device further includes a haptic feedback device and one or more sound output devices and alerting the wearer includes either providing a haptic alert using the haptic feedback device or a sound alert using the one or more sound output devices.

In some aspects, the techniques described herein relate to a method wherein the device further includes a communication component enabling a wireless connection with a second device, and alerting the wearer includes instructing the second device using the wireless connection to provide an alert via the second device.

In some aspects, the techniques described herein relate to a method wherein the first portion further includes one or more sound output devices that is physically segregated from the one or more in-canal microphones and one or more dampening materials positioned between the one or more sound output devices and the one or more in-canal microphones.

In some aspects, the techniques described herein relate to a method wherein the second portion further includes a feedforward microphone, and the method further includes if the one or more microphones are activated to receive the speech of the wearer: performing beamforming to focus the one or more microphones on a mouth of the wearer; receiving a second signal from the one or more microphones, the second signal generated from the speech of the wearer; receiving a third signal from the feedforward microphone, the third signal generated from the environmental noise; generating, based on the third signal, a noise cancellation signal; and causing the one or more sound output devices to output sound based on the noise cancellation signal.

In some aspects, the techniques described herein relate to one or more non-transitory computer-readable media including executable instructions that when executed by one or more processors of a system cause the system to perform a method including: receiving one or more first signals from one or more microphones generated from environmental noise, the one or more microphones included in a second portion included in a device and configured to capture external sounds, the device further including a first portion configured to be at least partially inserted into an ear canal of a wearer, the first portion including one or more in-canal microphones configured to capture sounds or vibrations in the ear canal; determining, based on the one or more first signals, a level of the environmental noise; and based on the level of the environmental noise, either: activating the one or more in-canal microphones to receive speech of the wearer; activating the one or more microphones to receive the speech of the wearer; or activating both the one or more in-canal microphones and the one or more microphones to receive the speech of the wearer.

In some aspects, the techniques described herein relate to one or more non-transitory computer-readable media, the method further including if both the one or more in-canal microphones and the one or more microphones are activated to receive the speech of the wearer: determining a first clarity of the speech received from the one or more in-canal microphones; determining a second clarity of the speech received from the one or more microphones; and adjusting, based on the first clarity and the second clarity, a first weighting of the speech received from the one or more in-canal microphones and a second weighting of the speech received from the one or more microphones.

In some aspects, the techniques described herein relate to one or more non-transitory computer-readable media, the method further including: receiving one or more of a location of the device, a time, or a schedule of the wearer of the device; and prioritizing, based on one or more of the location, the time, or the schedule, either the one or more in-canal microphones or the one or more microphones to receive the speech of the wearer.

In some aspects, the techniques described herein relate to one or more non-transitory computer-readable media, the method further including if the one or more in-canal microphones is activated to receive the speech of the wearer: receiving a second signal from the one or more in-canal microphones, the second signal generated from the speech of the wearer; determining, based on the second signal, an intensity of the speech; and based on the intensity of the speech, either: alerting the wearer to reduce the intensity of the speech; or alerting the wearer to increase the intensity of the speech.

In some aspects, the techniques described herein relate to one or more non-transitory computer-readable media wherein the device further includes a haptic feedback device and one or more sound output devices and alerting the wearer includes either providing a haptic alert using the haptic feedback device or a sound alert using the one or more sound output devices.

In some aspects, the techniques described herein relate to one or more non-transitory computer-readable media wherein the device further includes a communication component enabling a wireless connection with a second device, and alerting the wearer includes instructing the second device using the wireless connection to provide an alert via the second device.

In some aspects, the techniques described herein relate to one or more non-transitory computer-readable media wherein the first portion further includes one or more sound output devices that is physically segregated from the one or more in-canal microphones and one or more dampening materials positioned between the one or more sound output devices and the one or more in-canal microphones.

In some aspects, the techniques described herein relate to one or more non-transitory computer-readable media wherein the second portion further includes a feedforward microphone, and the method further includes if the one or more microphones are activated to receive the speech of the wearer: performing beamforming to focus the one or more microphones on a mouth of the wearer; receiving a second signal from the one or more microphones, the second signal generated from the speech of the wearer; receiving a third signal from the feedforward microphone, the third signal generated from the environmental noise; generating, based on the third signal, a noise cancellation signal; and causing the one or more sound output devices to output sound based on the noise cancellation signal.

### Voice Effort Reduction for Occluded Ear Agent Interaction

In-canal earbuds and hearing aids commonly occlude the ear canal, making ambient sounds and one's own voice seem muffled. This partial loss of natural auditory feedback can cause users to speak louder than necessary, which is sometimes known as the occlusion effect, which may lead to discomfort and disruption in shared or quiet environments. Certain solutions such as vented ear tips or active noise cancellation for external sounds may improve user comfort, but they do not address real-time monitoring and adjustment of the user's vocal intensity, especially when speaking to an artificial intelligence agent.

The described technology provides technical solutions to these technical problems. Users speaking with occluded ears unwittingly raise their voice because they have an inaccurate perception of loudness. A system according to the described technology may leverage an in-canal microphone to analyze the user's speech intensity in real time. Subtle feedback mechanisms (haptic vibrations, tonal cues, or visual indicators) prompt the user to lower or adjust their speaking volume when levels exceed optimal thresholds. The system also adapts to ambient noise conditions, allowing for comfortable voice effort whether the user is in a quiet library or a bustling train station. Over time, a user training module records personal voice patterns and guides the user toward more consistent, comfortable speaking levels—particularly crucial for lengthy conversations with an artificial intelligence agent.

The system continuously measures vocal amplitude, factoring in the natural occlusion effect, and gently prompts the user with alerts (for example, haptic or tonal alerts) when speech volume exceeds or falls below desired thresholds. In some embodiments, the system adjusts acceptable volume ranges based on user profile and environmental noise. Users can select the type of feedback they find most comfortable (vibration, audio tone, LED flash on paired device, etc.).

The system may identify background noise level and adjust thresholds accordingly. The system may automatically refine feedback parameters as the user moves between quiet and noisy surroundings. The system may also create a personal voice profile by storing average speaking amplitude and patterns for a user over time. The system may also provide progress tracking and coaching by providing insights or notifications that help users learn to maintain consistent, comfortable voice levels with occluded ears.

An example use case involves a user wearing in-canal earbuds on a crowded commuter train. As the user asks the artificial intelligence agent for travel updates, the in-canal microphone detects that the user is speaking at a higher volume than needed. The system gently provides haptic feedback, nudging the user to reduce vocal effort. The user's speech then hits the acceptable intensity range, preserving battery life for noise-canceling features and preventing unwanted disruption to fellow passengers.

A potential application of the technology includes consumer earbuds and hearing aids, as the system may alleviate excessive vocal loudness in daily communication with artificial intelligence agents. Another potential application is for workplace communication: the system may help employees in open-plan offices maintain quieter speech, thereby promoting a more pleasant environment. Another potential application is in healthcare and clinical settings, where the system may encourage softer, confidential speech in sensitive environments where privacy is important, and in military and security settings, where the system may aid personnel needing discreet interactions with artificial intelligence agents, ensuring they do not inadvertently raise their voices.

One advantage of the technology is improved comfort and social discretion, as users may learn to speak more softly in enclosed public settings or quiet workplaces. Another advantage is more efficient voice artificial intelligence agent interaction: the system may preserve accurate speech recognition by regulating volume spikes. Another advantage relates to context-aware operation: the system may automatically shift speaking thresholds in response to changing ambient noise conditions. The system may also provide for personalized training: over time, the user may refine his or her vocal habits, even transitioning seamlessly between occluded and non-occluded environments. The system may also integrate into existing earbud, hearing aid, or wearable designs with minimal or reduced hardware adjustments.

### Dual-Channel Audio Isolation Architecture

Current earbuds and headsets typically share compact enclosures for both microphone input and speaker output. Because of this, crosstalk or acoustic interference can arise, causing diminished audio quality or unintended feedback loops. While noise-canceling techniques reduce external sounds, they do not always isolate the microphone channel from the speaker output completely, particularly in more advanced setups where voice assistants are used frequently. Moreover, conventional materials and designs often fail to prevent audio leakage into the environment, compromising the user's privacy.

The described technology provides technical solutions to these technical problems. The proliferation of voice assistants integrated into personal headsets has heightened the need for robust privacy and clearer audio signals. Users frequently give voice commands or engage in private communications that should not be overheard. Simultaneously, users wish to hear responses from the agent without losing clarity or leaking sound externally. By establishing two physically and acoustically distinct channels in one ear-worn device—one for capturing in-canal speech input and the other for sound output—a system according to the technology ensures there is minimal risk of feedback, interference, or sound leakage. Carefully placed resonance-dampening materials and isolation barriers further guarantee a clean and discrete audio environment, both inside and outside the ear.

The system utilizes two distinct audio pathways, one exclusively for user input and one for sound output, that are both fully isolated from each other and from external environmental sounds. The microphone and speaker components reside in separate compartments within the earbud, reducing direct acoustic coupling. In some embodiments, the system utilizes layered materials (for example, silicone, foam composites) to trap and absorb sound within the earbud enclosure. In addition, the system utilizes ventilation and targeted cable routing to prevent unwanted audio paths while maintaining airflow and user comfort.

The system directs audio into the ear canal, minimizing spillover into the surrounding area. Resonance-dampening materials may be positioned between the microphone and speaker assemblies to absorb vibrations. The system may also utilize frequency-specific damping that is tuned to target the most common ranges for speech and artificial intelligence agent output, thereby mitigating internal crosstalk.

The system may utilize sensors and software algorithms to detect unintended sound escaping from either channel and may make automated adjustments (for example, phase inversion) to reduce or eliminate detected leakage in real time.

An example use case of the technology is a user working in an open-plan office environment, making sensitive requests to an artificial intelligence agent. The isolated in-canal microphone picks up the user's voice with minimal background noise, while the sealed output driver delivers artificial intelligence responses to only the user's ear. Co-workers remain undisturbed, and there is no or minimal risk of acoustic feedback or inadvertent sound leakage revealing private information

A potential application of the technology is for private corporate communications, where highly confidential voice commands and agent responses in open-office setups may be important. Another potential application is in consumer devices such as earbuds or headsets to allow users to make and receive discreet phone calls and artificial intelligence agent interactions without disturbing others. Other potential applications are in government and military settings, where operations may require minimal or reduced sound leakage and reliable voice capture, and in healthcare environments, where medical professionals can discreetly interact with artificial intelligence agents while ensuring patient privacy.

Advantages of the technology include providing improved privacy, as the system may prevent both external audibility and crosstalk between user and agent audio channels and provide enhanced clarity, as the system reduces or eliminates feedback loops, thereby ensuring high-quality sound capture and playback. Other advantages relate to real-time monitoring, as the automated leakage detection may allow for the system to continuously correct acoustic anomalies, and user comfort and practicality, as physical isolation barriers and tuned damping help maintain a compact form factor. The technology also has broad utility, as the system may be utilized in a variety of consumer, professional, and specialized ear-worn devices.

### Directional Voice Focusing

Existing consumer microphones, such as those in conventional earbuds or headsets, are typically omnidirectional or only mildly directional, leading to potential issues with background noise, lack of privacy, and reduced clarity. Conventional beamforming techniques often enhance the user's voice relative to ambient noise but can still capture undesired sounds, especially in public or noisy environments. Additionally, many solutions do not address confidentiality; if a user speaks at normal volume, there may still be a risk that bystanders can overhear, and the microphone may also pick up extraneous chatter.

The described technology provides technical solutions to these technical problems. Voice assistants and artificial intelligence systems rely on clear, accurate voice input for best performance. However, modern workspaces and public areas can be extremely noisy, and users desire private interactions. A system according to the described technology employs a directional microphone assembly and destructive interference tactics to capture the user's speech with precision while suppressing or eliminating background noise. The adaptive focusing feature accommodates user-specific mouth and face geometry, further refining capture precision and preventing leakage of speech to the surroundings.

The system may utilize an array of phase-manipulated microphones configured to pick up sound primarily from the user's mouth, rejecting signals outside the narrow capture zone. The system may apply adaptive gain control in real time by amplifying the user's voice while minimizing ambient noise. The system may utilize other sensors to detect ambient noise sources, generating out-of-phase signals to partially negate background interference. The system may adjust interference patterns to account for shifting environmental noise profiles. The system may also adapt based on characteristics of the user. The system may calibrate to the user's mouth position, facial structure, or jawline for optimal pickup angles and can account for small movements of the user's head or mouth in real time to maintain acceptable voice capture.

An example use case of the technology is a user on a commuter train who wants to give private commands to their smartphone's artificial intelligence agent. A typical microphone might pick up train noises and other passengers' conversations, diminishing accuracy. With this system, the user can speak at a normal volume, confident that the microphone array captures only their voice while blocking external sounds.

One potential application of the technology is in consumer headsets and earbuds, as the system provides enhanced voice command accuracy and privacy in varied settings, such as busy coffee shops, public transport, or offices. Another setting in which the technology may be used is in office environments, as the system provides secure dictation tools for confidential corporate or legal settings where privacy is important. Other potential applications of the technology are in medical and assistive devices to allow for clear speech capture for patients or users with voice impairments, reducing ambient noise impact, and in military and security devices, where discreet, reliable communication in noisy or sensitive contexts is important.

Advantages of the technology include improved speech accuracy, as the directional array reduces interference from external sources and enhanced privacy, as the system limits how much a user must raise their voice, thereby minimizing or reducing speech leakage to the surrounding area. Another advantage relates to adaptive noise control, as the system may make real-time adjustments to handle changes in the environment, thereby delivering consistent performance in dynamic or unpredictable settings. The system may also be used in various devices, from personal consumer wearables to specialized, high-security applications. The system allows for a user-centric design, as the system's ability to recalibrate ensures comfort and reliability even as the user moves or changes posture.

### Adaptive Occlusion Effect Compensation for In-Canal Ear Devices

In closed-back or fully occluded in-canal devices, users benefit from superior noise isolation and the ability to capture voice with minimal external interference. However, these advantages come at the cost of internal body noise amplification. Vibrations from speaking, chewing, or movement can resonate within the sealed ear canal, causing discomfort, distorted self-perception of voice volume (leading users to speak louder), and distracting drumming or pulsating sounds (for example, footsteps, heartbeat). Current attempts at tackling occlusion rely on partial venting or rudimentary equalization, which can degrade noise cancellation quality or fail to address dynamic scenarios (for example, transitioning from stillness to activity).

The described technology provides technical solutions to these technical problems. A system according to the described technology may dynamically remove body-borne noises and maintain high-quality, closed-back audio performance. In some embodiments, the system may utilize the in-canal microphone to pick up vibrations and resonances traveling through the wearer's body (for example, chewing, heartbeat). The system may apply phase-inverted signals or specialized algorithms to subtract or attenuate these body noises, preserving clarity in the user's self-perception and conversation.

The system may adjust equalization in real time to reduce the “boomy” or muffled sensation of one's own voice, thereby enabling natural speech levels. The system also may provide dynamic transparency by augmenting certain external frequency bands or reintroducing external ambient noise to prevent an overly enclosed feel, with minimal or reduced impact on in-ear audio fidelity. The system may process the user's speech to reduce the harshness or overly amplified resonance caused by the in-canal seal. For example, the system may remove internal echoes or reflections within the sealed ear canal. Doing so may facilitate clear artificial intelligence agent communications and minimal or reduced interference for the user.

This system retains the strong benefits of a closed-back approach, such as deep bass and minimal external noise intrusion, while compensating for the drawbacks of occlusion. The result is an enhanced user experience, ideal for applications where high-fidelity audio, effective voice capture, and discreet conversation with an artificial intelligence agent are desired.

An example use case of the technology involves a user wearing custom in-canal earbuds with a personal artificial intelligence agent who is walking through a busy street. The user starts chewing gum and notices that the typical in-ear thumping or drumming is absent. The system's adaptive occlusion compensation filters out these body-borne sounds and maintains a comfortable self-voice perception. Simultaneously, the user can quietly converse with the device's artificial intelligence agent about directions or schedule updates, enjoying excellent voice capture (no or reduced external noise bleed) and a rich, immersive music background track.

FIG. 6 is a flow diagram illustrating an example method 600 that some embodiments of aspects of the described technology may perform. The method 600 may begin at step 602, where a signal from one or more in-canal microphones positioned in an ear canal of a person is received. The signal is generated from sounds or vibrations in the ear canal captured by the one or more in-canal microphones. The one or more in-canal microphones are included in a portion of a device worn by the person. The portion is positioned at least partially in the ear canal. The portion also includes one or more sound output devices configured to output sounds in the ear canal.

At step 604, based on the signal, it is determined that the sounds or vibrations are not speech of the person. At step 606, based on the signal, a noise cancellation signal is generated. At step 608, the one or more sound output devices are caused to output sounds based on the noise cancellation signal.

In some aspects, the techniques described herein relate to a device including: a portion configured to be positioned at least partially in an ear canal of a wearer, the portion including one or more in-canal microphones configured to capture sounds or vibrations in the ear canal and one or more sound output devices configured to output sounds in the ear canal; one or more processors; and one or more memories storing instructions that upon execution by the one or more processors cause the device to perform a method, the method including: receiving a signal from the one or more in-canal microphones, the signal generated from sounds or vibrations in the ear canal captured by the one or more in-canal microphones; determining, based on the signal, that the sounds or vibrations are not speech of the wearer; generating, based on the signal, a noise cancellation signal; and causing the one or more sound output devices to output sounds based on the noise cancellation signal.

In some aspects, the techniques described herein relate to a device wherein the sounds or vibrations are first sounds or vibrations, the signal is a first signal, the sounds are first sounds, and the method further includes: receiving a second signal from the one or more in-canal microphones, the second signal generated from second sounds or vibrations in the ear canal captured by the one or more in-canal microphones; determining, based on the second signal, that the second sounds or vibrations are speech of the wearer; adjusting an equalization of the second signal to obtain an equalized second signal; and causing the one or more sound output devices to output second sounds based on the equalized second signal.

In some aspects, the techniques described herein relate to a device wherein the portion is a first portion, the device further includes a second portion including multiple microphones configured to capture sounds external to the wearer, the signal is a first signal, the sounds are first sounds, and the method further includes: receiving multiple second signals from the multiple microphones, the multiple second signals generated from sounds external to the wearer captured by the multiple microphones; processing the multiple second signals to obtain multiple processed second signals; and causing the one or more sound output devices to output second sounds based on the multiple processed second signals.

In some aspects, the techniques described herein relate to a device wherein processing the multiple second signals to obtain the multiple processed second signals includes increasing one or more frequency bands of the multiple second signals.

In some aspects, the techniques described herein relate to a device wherein the sounds or vibrations are first sounds or vibrations, and the method further includes: receiving a third signal from the one or more in-canal microphones, the third signal generated from second sounds or vibrations in the ear canal captured by the one or more in-canal microphones; determining, based on the third signal, that the second sounds or vibrations are speech of the wearer; processing the third signal to reduce echo or resonance in the speech of the wearer; and causing the one or more sound output devices to output third sounds based on the processed third signal.

In some aspects, the techniques described herein relate to a method including: receiving a signal from one or more in-canal microphones positioned in an ear canal of a person, the signal generated from sounds or vibrations in the ear canal captured by the one or more in-canal microphones, the one or more in-canal microphones included in a portion of a device worn by the person, the portion positioned at least partially in the ear canal, the portion further including one or more sound output devices configured to output sounds in the ear canal; determining, based on the signal, that the sounds or vibrations are not speech of the person; generating, based on the signal, a noise cancellation signal; and causing the one or more sound output devices to output sounds based on the noise cancellation signal.

In some aspects, the techniques described herein relate to a method wherein the sounds or vibrations are first sounds or vibrations, the signal is a first signal, the sounds are first sounds, and further including: receiving a second signal from the one or more in-canal microphones, the second signal generated from second sounds or vibrations in the ear canal captured by the one or more in-canal microphones; determining, based on the second signal, that the second sounds or vibrations are speech of the person; adjusting an equalization of the second signal to obtain an equalized second signal; and causing the one or more sound output devices to output second sounds based on the equalized second signal.

In some aspects, the techniques described herein relate to a method wherein the portion is a first portion, the device further includes a second portion including multiple microphones configured to capture sounds external to the person, the signal is a first signal, the sounds are first sounds, and further including: receiving multiple second signals from the multiple microphones, the multiple second signals generated from sounds external to the person captured by the multiple microphones; processing the multiple second signals to obtain multiple processed second signals; and causing the one or more sound output devices to output second sounds based on the multiple processed second signals.

In some aspects, the techniques described herein relate to a method wherein processing the multiple second signals to obtain the multiple processed second signals includes increasing one or more frequency bands of the multiple second signals.

In some aspects, the techniques described herein relate to a method wherein the sounds or vibrations are first sounds or vibrations, and the method further includes: receiving a third signal from the one or more in-canal microphones, the third signal generated from second sounds or vibrations in the ear canal captured by the one or more in-canal microphones; determining, based on the third signal, that the second sounds or vibrations are speech of the person; processing the third signal to reduce echo or resonance in the speech of the wearer; and causing the one or more sound output devices to output third sounds based on the processed third signal.

In some aspects, the techniques described herein relate to one or more non-transitory computer-readable media including executable instructions that when executed by one or more processors of a system cause the system to perform a method including: receiving a signal from one or more in-canal microphones positioned in an ear canal of a person, the signal generated from sounds or vibrations in the ear canal captured by the one or more in-canal microphones, the one or more in-canal microphones included in a portion of a device worn by the person, the portion positioned at least partially in the ear canal, the portion further including one or more sound output devices configured to output sounds in the ear canal; determining, based on the signal, that the sounds or vibrations are not speech of the person; generating, based on the signal, a noise cancellation signal; and causing the one or more sound output devices to output sounds based on the noise cancellation signal.

In some aspects, the techniques described herein relate to one or more non-transitory computer-readable media wherein the sounds or vibrations are first sounds or vibrations, the signal is a first signal, the sounds are first sounds, and the method further includes: receiving a second signal from the one or more in-canal microphones, the second signal generated from second sounds or vibrations in the ear canal captured by the one or more in-canal microphones; determining, based on the second signal, that the second sounds or vibrations are speech of the person; adjusting an equalization of the second signal to obtain an equalized second signal; and causing the one or more sound output devices to output second sounds based on the equalized second signal.

In some aspects, the techniques described herein relate to one or more non-transitory computer-readable media wherein the portion is a first portion, the device further includes a second portion including multiple microphones configured to capture sounds external to the person, the signal is a first signal, the sounds are first sounds, and the method further includes: receiving multiple second signals from the multiple microphones, the multiple second signals generated from sounds external to the person captured by the multiple microphones; processing the multiple second signals to obtain multiple processed second signals; and causing the one or more sound output devices to output second sounds based on the multiple processed second signals.

In some aspects, the techniques described herein relate to one or more non-transitory computer-readable media wherein processing the multiple second signals to obtain the multiple processed second signals includes increasing one or more frequency bands of the multiple second signals.

In some aspects, the techniques described herein relate to one or more non-transitory computer-readable media wherein the sounds or vibrations are first sounds or vibrations, and the method further includes: receiving a third signal from the one or more in-canal microphones, the third signal generated from second sounds or vibrations in the ear canal captured by the one or more in-canal microphones; determining, based on the third signal, that the second sounds or vibrations are speech of the person; processing the third signal to reduce echo or resonance in the speech of the wearer; and causing the one or more sound output devices to output third sounds based on the processed third signal.

### Whispered Speech Recognition

Conventional voice recognition engines are primarily trained on normal-volume speech. When users whisper, significant high-frequency and amplitude content is lost, degrading recognition accuracy. Moreover, privacy-conscious individuals often avoid speaking aloud in shared or public spaces, but existing voice systems are not tuned to capture quiet, breathy vocalizations. Furthermore, conventional microphone arrays are not always optimized for bone-conducted whispers, making them prone to missing or misidentifying commands delivered at whisper-level amplitude.

The described technology provides technical solutions to these technical problems. A system according to the described technology may integrate whisper-specific acoustic models within the speech recognition pipeline. In-canal earbuds may leverage bone conduction to capture even the faintest vocalizations, while amplification and filtering techniques may allow for isolation of whispered frequencies. A privacy mode may allow users to communicate with an artificial intelligence agent silently in libraries, open-plan offices, or public transportation, ensuring minimal disruption to the surroundings. Through a user training module, individuals may learn to produce optimal whisper levels that balance clarity and stealth, further enhancing accuracy and user comfort.

In some embodiments, the system may utilize in-canal microphones combined with whisper-specific recognition models and amplification to achieve accurate, low-volume speech capture for silent, discreet user-agent conversations. The models may be trained on datasets of whispered vocal samples covering different accents and intensities. The system may utilize phoneme mapping that accounts for the breathy, low-amplitude characteristics unique to whispering.

The system may utilize amplification techniques for whispered voice patterns, such as adaptive gain control to dynamically boost near-silent signals while minimizing noise artifacts, and accentuating whispered consonant formation (for example, /s/ or /f/) often lost in quiet speech.

The privacy mode may ensure that minimal sound escapes the user's immediate vicinity. The system may use context-aware activation by automatically switching to whisper-detection mode in recognized quiet or sensitive environments. The system may provide guided exercises through on-device tutorials that teach acceptable whisper volumes and enunciations. The system may also provide real-time feedback through subtle auditory, haptic, or visual cues to notify users if their whisper is too faint or too strong for clear recognition.

In some embodiments, the system may utilize adaptive gain control and bone-conducted speech processing to recognize whispered speech. The system may utilize in-canal sensors that capture subtle vocal vibrations transmitted through the user's bones and soft tissues. The system may recognize that the user is whispering through models that are trained on whisper-level inputs, facilitating robust recognition even with minimal vocal output.

The system may use adaptive gain control for whispered input by automatically boosting only the relevant whisper-range frequencies while minimizing noise. The system may use filters to remove environmental noise without compromising the clarity of the whisper signal.

In some embodiments, the system may compress whispered speech data to reduce bandwidth usage and potential interception points and encrypt the compressed data prior to transmitting the data. The system may detect quiet surroundings or user-defined private zones to automatically activate whisper mode. The system may learn user behavior and typical usage patterns so as to transition seamlessly between normal and whisper-level interaction.

An example use of technology involves a professional in a quiet coworking space who needs to quickly retrieve sensitive information from a cloud assistant. Rather than speaking at a normal volume, the professional whispers commands into an in-canal device. The system's whisper-adapted recognition models and amplification filters capture and interpret these low-amplitude signals accurately. Meanwhile, coworkers remain undisturbed, and the professional maintains privacy.

Another example use case is a user in a quiet library who needs to query an artificial intelligence agent regarding research materials or scheduling. By switching to whisper mode, the user can speak softly into the in-canal microphone. The system amplifies and processes this near-silent input for the voice assistant without disturbing anyone nearby or risking personal privacy. Once the conversation is over or the user leaves the library, the system reverts to a normal listening state automatically.

A potential application of the technology relates to use in libraries, offices, and classrooms, where the system may offer silent command-and-control for personal assistants in noise-restricted areas. Another potential application may be in healthcare and clinical settings, as the system may enable confidential patient data queries without raising one's voice. Another potential application may be in security and military settings, as the system may allow for discreet communication with artificial intelligence agents when auditory discretion is critical. The technology may also be utilized in public spaces, as the system may empower users with private, whispered voice interaction in public transit or crowded events and preserves user privacy by preventing overheard conversations while minimizing ambient noise pickup.

Advantages of the technology include enhanced privacy, as users can access artificial intelligence agents without broadcasting requests audibly, and better recognition accuracy, as whisper-specific acoustic models may outperform generic speech to text solutions in low-volume conditions. Another advantage relates to robust recognition: whisper-optimized voice modeling and bone conduction detection may improve command accuracy. Another advantage is the system may allow for minimal disruption and therefore may be suitable for quiet, shared, or formal settings. The system also may provide for efficient user training by providing guided whisper practice, which may build confidence and proficiency in near-silent communication. The system may also be integrated into various in-canal wearable devices and earbud designs.

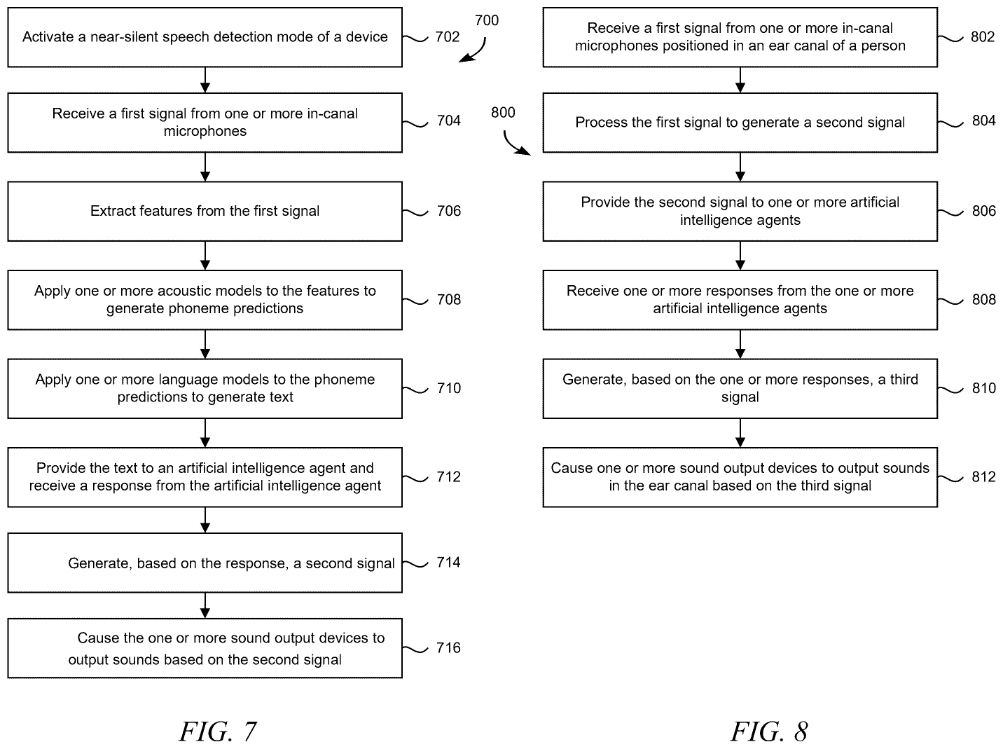

FIG. 7 is a flow diagram illustrating an example method 700 that some embodiments of aspects of the described technology may perform. The method 700 may begin at step 702, where a near-silent speech detection mode of a device is activated. The device has the near-silent speech detection mode and a normal speech detection mode. The device includes a portion positioned at least partially in an ear canal of a wearer of the device. The portion includes one or more in-canal microphones configured to capture sounds or vibrations in the ear canal and one or more sound output devices configured to output sounds in the ear canal. At step 704 a first signal from the one or more in-canal microphones is received. The first signal is generated from near-silent sounds or vibrations captured by the one or more in-canal microphones.

At step 706, features are extracted from the first signal. At step 708, one or more acoustic models are applied to the features to generate phoneme predictions. At step 710 one or more language models are applied to the phoneme predictions to generate text. At step 712, the text is provided to an artificial intelligence agent and a response from the artificial intelligence agent is received. At step 714, based on the response, a second signal is generated. At step 716 the one or more sound output devices are caused to output sounds based on the second signal.

Additional steps may be performed, such as amplifying the first signal prior to extracting features from the first signal.

In some aspects, the techniques described herein relate to a method including: activating a near-silent speech detection mode of a device, the device having the near-silent speech detection mode and a normal speech detection mode, the device including a portion positioned at least partially in an ear canal of a wearer of the device; the portion including one or more in-canal microphones configured to capture sounds or vibrations in the ear canal and one or more sound output devices configured to output sounds in the ear canal; receiving a first signal from the one or more in-canal microphones, the first signal generated from near-silent sounds or vibrations captured by the one or more in-canal microphones; extracting features from the first signal; applying one or more acoustic models to the features to generate phoneme predictions; applying one or more language models to the phoneme predictions to generate text; providing the text to an artificial intelligence agent; receiving a response from the artificial intelligence agent; generating, based on the response, a second signal; and causing the one or more sound output devices to output sounds based on the second signal.

In some aspects, the techniques described herein relate to a method, further including determining that the device is operating in a quiet environment, wherein the near-silent speech detection mode is activated in response to determining that the device is operating in the quiet environment.

In some aspects, the techniques described herein relate to a method wherein the portion is a first portion, the device further includes a second portion including multiple microphones configured to capture sounds external to the wearer, and further including receiving multiple second signals from the multiple microphones, the multiple second signals generated from sounds external to the wearer captured by the multiple microphones, wherein determining that the device is operating in the quiet environment is based on the multiple second signals.

In some aspects, the techniques described herein relate to a method, further including receiving a location of the device, wherein determining that the device is operating in the quiet environment is based on the location of the device.

In some aspects, the techniques described herein relate to a method, further including amplifying the first signal.

In some aspects, the techniques described herein relate to a method, wherein the one or more acoustic models are trained on near-silent speech.

In some aspects, the techniques described herein relate to a method, further including: determining, based on the first signal, an intensity of the near-silent sounds or vibrations; and alerting the wearer if the intensity is either below a first intensity threshold or above a second intensity threshold.

In some aspects, the techniques described herein relate to one or more non-transitory computer-readable media including executable instructions that when executed by one or more processors of a system cause the system to perform a method including: activating a near-silent speech detection mode of a device, the device having the near-silent speech detection mode and a normal speech detection mode, the device including a portion positioned at least partially in an ear canal of a wearer of the device; the portion including one or more in-canal microphones configured to capture sounds or vibrations in the ear canal and one or more sound output devices configured to output sounds in the ear canal; receiving a first signal from the one or more in-canal microphones, the first signal generated from near-silent sounds or vibrations captured by the one or more in-canal microphones; extracting features from the first signal; applying one or more acoustic models to the features to generate phoneme predictions; applying one or more language models to the phoneme predictions to generate text; providing the text to an artificial intelligence agent; receiving a response from the artificial intelligence agent; generating, based on the response, a second signal; and causing the one or more sound output devices to output sounds based on the second signal.

In some aspects, the techniques described herein relate to one or more non-transitory computer-readable media, the method further including determining that the device is operating in a quiet environment, wherein the near-silent speech detection mode is activated in response to determining that the device is operating in the quiet environment.

In some aspects, the techniques described herein relate to one or more non-transitory computer-readable media wherein the portion is a first portion, the device further includes a second portion including multiple microphones configured to capture sounds external to the wearer, and the method further includes receiving multiple second signals from the multiple microphones, the multiple second signals generated from sounds external to the wearer captured by the multiple microphones, wherein determining that the device is operating in the quiet environment is based on the multiple second signals.

In some aspects, the techniques described herein relate to one or more non-transitory computer-readable media, the method further including receiving a location of the device, wherein determining that the device is operating in the quiet environment is based on the location of the device.

In some aspects, the techniques described herein relate to one or more non-transitory computer-readable media, the method further including amplifying the first signal.

In some aspects, the techniques described herein relate to one or more non-transitory computer-readable media, wherein the one or more acoustic models are trained on near-silent speech.

In some aspects, the techniques described herein relate to one or more non-transitory computer-readable media, the method further including: determining, based on the first signal, an intensity of the near-silent sounds or vibrations; and alerting the wearer if the intensity is either below a first intensity threshold or above a second intensity threshold.

### Bone-Conducted Voice Quality Enhancement

Existing in-canal and bone-conduction systems typically pick up low-frequency-dominant speech signals, as bone conduction tends to attenuate higher frequencies crucial for clarity and natural timbre. While such methods may reduce ambient noise, they often yield a muffled or unnatural vocal quality. Conventional hearing aids, bone-conduction headsets, and some in-ear monitors attempt partial compensations via equalization, but they do not integrate advanced articulation enhancement or resonance modeling to fully restore a user's authentic sounding voice. Meanwhile, digital voice assistants rely heavily on speech clarity for accurate command interpretation and more natural conversational experiences.

The described technology provides technical solutions to these technical problems. A system according to the described technology may use a set of signal processing techniques—spectral balancing, articulation enhancement, resonance modeling—combined with A/B testing to refine and restore more natural voice characteristics. When users speak through bone conduction, critical higher-frequency components may be underrepresented, resulting in an atypically bass-heavy or dull sound signature that can degrade recognition accuracy for artificial intelligence agents and create an unnatural user experience. The system may apply spectral balancing to lift weaker high-frequency bands and articulation enhancement techniques targeting consonant formation to restore a more typical air-conducted vocal profile. Additionally, the system may utilize resonance modeling to simulate certain aspects of head and upper vocal tract resonance missing in purely bone-conducted signals. The system may provide an A/B testing framework to allow for the comparison of processed and unprocessed signals, which may allow for refining the algorithms for improved voice quality and agent interaction performance.

The system may utilize spectral balancing techniques to account for bone-conduction frequency limitations. For example, the system may utilize dynamic equalization that boosts or smooths specific frequency bands underrepresented in bone-conducted speech. The system may adjust equalization in real time based on measured speech intensity and user-specific bone conduction profiles.

The system may utilize articulation enhancement techniques to improve focus on consonant clarity, such as by selectively amplifying or sharpening high-frequency phonetic elements (for example, /s/, /t/, /ch/) that typically get lost in bone conduction. The system may also preserve rapid onset cues critical for differentiating similar sounds in whispered or lower-volume speech.

The system may utilize resonance modeling techniques to restore natural vocal qualities, such as by simulating the head and vocal tract to reintroduce frequency characteristics typically shaped by air conduction in the mouth and nasal cavity. The system may also adapt to the user's changing vocal dynamics, capturing variations in pitch, timbre, and inflection in real-time.

The system may utilize an A/B testing framework for quality comparison and optimization. The system may simultaneously process bone-conducted input and enhanced output, enabling quick toggling or side-by-side playback. The system may collect subjective quality ratings and objective speech recognition metrics from users to refine processing parameters.

An example use case of the technology involves a user talking to an artificial intelligence agent via in-canal earbuds while commuting in a noisy subway. Conventional bone-conduction pickups would create a muffled, low-frequency-biased signal that might lead to misinterpretations by the artificial intelligence agent or perceived awkwardness during voice calls. The system dynamically balances the high-frequency deficits and enhances articulation so consonants like “t,” “s,” and “f” remain crisp, allowing for more natural-sounding conversation with the artificial intelligence agent, even in challenging acoustic environments.

One potential application of the technology is for consumer earbuds and headsets: the system may improve clarity for voice assistant commands and phone calls in noisy or privacy-sensitive environments. Another potential application is in hearing aids and assistive devices: the system may provide more authentic voice output for individuals relying on bone conduction for speech capture. Other potential applications are in enterprise and call centers settings, as the system may help employees who use discreet in-canal devices maintain professional call quality, and in medical and military settings, as the system may ensure intelligible, stable voice performance in specialized settings where bone conduction is preferred.

One advantage of the technology relates to improved speech intelligibility, as the system may address the known deficiency of bone conduction in reproducing higher frequencies. Another advantage relates to natural sound quality, by resonance modeling, the system may allow voice warmth and expressiveness to be retained, which may enhance user confidence in agent interactions. The system also may provide improved recognition accuracy: artificial intelligence agents benefit from clearer voice input, thereby reducing misinterpretation and user frustration. The system may also adapt in real-time, as dynamic algorithms handle various speaking volumes or environmental contexts (for example, quiet offices vs. noisy outdoors). The system may also allow for refinement, as the A/B testing framework may drive iterative improvements, ensuring both objective and user-driven metrics guide enhancements.

FIG. 8 is a flow diagram illustrating an example method 800 that some embodiments of aspects of the described technology may perform. The method 800 may begin at step 802 where a first signal from one or more in-canal microphones positioned in an ear canal of a person is received. The first signal is generated from bone-conducted speech captured by the one or more in-canal microphones. The one or more in-canal microphones are included in a portion of a device worn by the person that is positioned at least partially in the ear canal. The portion also includes one or more sound output devices configured to output sounds in the ear canal.

At step 804, the first signal is processed to generate a second signal, by adjusting an equalization of the first signal, modifying one or more frequency bands of the first signal, and amplifying one or more portions of the first signal. At step 806, the second signal is provided to one or more artificial intelligence agents. At step 808, one or more responses from the one or more artificial intelligence agents are received. At step 810 based on the one or more responses, a third signal is generated. At step 812, the one or more sound output devices are caused to output sounds based on the third signal.

In some aspects, the techniques described herein relate to a method including: receiving a first signal from one or more in-canal microphones positioned in an ear canal of a person, the first signal generated from bone-conducted speech captured by the one or more in-canal microphones, the one or more in-canal microphones included in a portion of a device worn by the person, the portion positioned at least partially in the ear canal, the portion further including one or more sound output devices configured to output sounds in the ear canal; processing the first signal to generate a second signal, by: adjusting an equalization of the first signal; modifying one or more frequency bands of the first signal; and amplifying one or more portions of the first signal; providing the second signal to one or more artificial intelligence agents; receiving one or more responses from the one or more artificial intelligence agents; generating, based on the one or more responses, a third signal; and causing the one or more sound output devices to output sounds based on the third signal.

### Adaptive Speech-to-Text Processing for Sub-Vocalized Commands

Conventional speech-to-text (STT) algorithms assume audible vocal output at normal or slightly reduced volumes. Commercial solutions typically do not address the extreme low-volume range associated with sub-vocalization. In sub-vocalization, vocal cords vibrate minimally, and many speech formants lie below typical detection thresholds. Traditional voice activity detection (VAD) and standard machine learning-based STT models often fail to accurately identify phonemes when speech amplitude is so low. Additionally, in-canal microphones introduce unique acoustic profiles—particularly an emphasis on bone-conducted components in sub-1 kHz frequencies—which standard STT pipelines do not fully accommodate.

The described technology provides technical solutions to these technical problems. For privacy or discreteness, users often want to issue near-silent commands to artificial intelligence agents—for example, in a library, during a meeting, or in other noise-sensitive environments. Standard STT systems struggle to detect or interpret sub-vocal signals, often discarding them as background noise. A system according to the described technology may utilize sensitive VAD, amplified detection hardware, and machine learning models specifically trained on progressively quieter speech samples. Transformer architectures optimized for in-canal, bone-conducted data may allow the system to accurately parse low-amplitude phonemes. A user training system may guide individuals to produce sub-vocal speech effectively, which may improve the system's recognition rate over time.

The system may provide sensitive VAD through monitoring tiny fluctuations in the user's vocal tract and activating STT processing only upon verifying authentic sub-vocal input. The system processes the signal for sub-vocal speech recognition through adaptive gain control—dynamically boosting low-amplitude signals typical of sub-vocalization—and noise suppression—filtering out peripheral sound while preserving faint vocal cues.

To recognize speech, the system may apply machine learning models trained on progressively quieter speech samples. The system may utilize an acoustic model that is trained on a wide range of sub-vocal intensities and bone-conducted examples. The system may adapt to various user accents and sub-vocalization styles, thereby improving accuracy over time. The system may also use transformer models for in-canal, bone-conducted speech. The models may focus on sub-1 kHz signals typically associated with bone conduction. The system may utilize self-attention mechanisms to decode subtle differences in low-volume phonemes.

The system may provide a training system to assist users in developing effective sub-vocalization techniques. For example, the system may provide guided exercises through on-device tutorials that help users master mouth and throat positions for reliable sub-vocal signals. The system may also provide feedback and metrics through real-time scoring to ensure users can track improvements in clarity and consistency.

An example use case of the technology is a user in a quiet library who needs to check messages or get information from an artificial intelligence agent without disturbing others. By sub-vocalizing commands, the user barely moves their lips or generates audible sound, yet the in-canal microphone detects faint vibrations. The adaptive STT system interprets these signals accurately, providing silent feedback on a smartwatch or earbud interface. Over time, the user learns an optimal sub-vocalization technique through guided practice, refining their silent communication with the AI assistant.

Potential applications of the technology relate to use in quiet environments such as libraries, offices, or conferences where discreet voice commands are important and in military and security settings, where certain scenarios may require near-silent speech. Another potential application is in accessibility solutions, as people with vocal strain or partial aphonia can still communicate commands sub-vocally. Yet another potential use of the technology is in consumer wearables such as earbuds and smart devices that support silent interactions in shared public spaces.

One advantage of the technology relates to the fact that near-silent operation preserves privacy and avoids social discomfort. Another advantage is that sub-vocal signals may be less prone to environmental noise, and thus there may be reduced ambient interference, which may result in improved STT accuracy. Another advantage relates to personalized learning: users may develop consistent sub-vocal techniques, which may improve system performance over time. Another advantage is that transformer-based models may be capable of handling complex linguistic contexts, thereby enabling advanced artificial intelligence agent interactions. Yet another advantage is that the technology may be applicable to a broad variety of settings, such as consumer settings, security/defense environments, and healthcare settings.

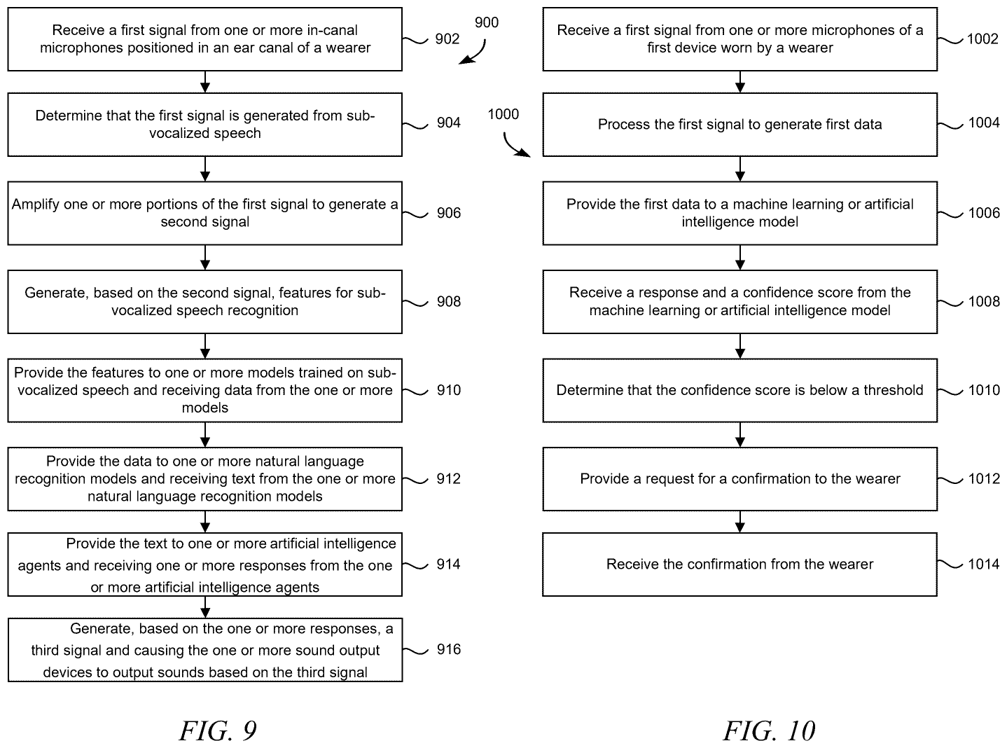

FIG. 9 is a flow diagram illustrating an example method 900 that some embodiments of aspects of the described technology may perform. The method 900 may begin at step 902, where a first signal from one or more in-canal microphones positioned in an ear canal of a person is received. The first signal is generated from speech captured by the one or more in-canal microphones. The one or more in-canal microphones are included in a portion of a device worn by the person. The portion is positioned at least partially in the ear canal. The portion also includes one or more sound output devices configured to output sounds in the ear canal.

At step 904, it is determined that the first signal is generated from sub-vocalized speech. At step 906, one or more portions of the first signal are amplified to generate a second signal. At step 908, based on the second signal, features for sub-vocalized speech recognition are generated. At step 910, the features are provided to one or more models trained on sub-vocalized speech and data from the one or more models is received. At step 912, the data is provided to one or more natural language recognition models and text from the one or more natural language recognition models is received. At step 914 the text is provided to one or more artificial intelligence agents and one or more responses from the one or more artificial intelligence agents are received. At step 916, based on the one or more responses, a third signal is generated, and the one or more sound output devices are caused to output sounds based on the third signal.

In some aspects, the techniques described herein relate to a method including: receiving a first signal from one or more in-canal microphones positioned in an ear canal of a person, the first signal generated from speech captured by the one or more in-canal microphones, the one or more in-canal microphones included in a portion of a device worn by the person, the portion positioned at least partially in the ear canal, the portion further including one or more sound output devices configured to output sounds in the ear canal; determining that the first signal is generated from sub-vocalized speech; amplifying one or more portions of the first signal to generate a second signal; generating, based on the second signal, features for sub-vocalized speech recognition; providing the features to one or more models trained on sub-vocalized speech; receiving data from the one or more models; providing the data to one or more natural language recognition models; receiving text from the one or more natural language recognition models; providing the text to one or more artificial intelligence agents; receiving one or more responses from the one or more artificial intelligence agents; generating, based on the one or more responses, a third signal; and causing the one or more sound output devices to output sounds based on the third signal.

### Multimodal Confirmation for Low-Confidence In-Canal Voice Commands

Voice assistants typically rely on confidence scores output by speech recognition engines to confirm command accuracy. If that score drops below a certain threshold, the system may misinterpret user intent. In in-canal devices, limited frequency range—especially for higher-frequency consonants—can further reduce recognition reliability. Conventional solutions often resort to repeating or re-prompting the user, which can feel intrusive or disruptive. Existing platforms do not employ a layered approach that dynamically switches across haptic, visual, and context-aware channels, all while considering user history, to minimize or reduce friction in the interactions.

The described technology provides technical solutions to these technical problems. When an in-canal voice command triggers a low recognition confidence score, a system according to the described technology may automatically request secondary confirmation. The user may receive a haptic prompt (for example, a subtle earbud vibration) indicating a need for validation. If the user has access to a connected device with a display—like a smartwatch or smartphone—a visual confirmation dialog may appear, offering quick approval or correction of the interpreted command. Furthermore, a prediction engine driven by user history and contextual cues may suggest the most likely commands (for example, frequent destinations, routine tasks), enabling a simpler yes/no confirmation if the recognized text is close to one of these predictable options. This multimodal approach may ensure minimal disruption and enhance accuracy while reducing repeated verbal queries.

The system may set a confidence threshold for ambiguous commands. If speech recognition confidence falls below a preset value, the system may mark the command as uncertain. In some embodiments, the system may adjust the threshold based on user speech patterns, noise levels, or real-time environmental inputs.

In some embodiments, the system may request secondary confirmation through haptic feedback requests. For example, the system may provide a short tap or buzz sequence to signal the user that confirmation is required. A single tap or a double tap by the user may accept or reject the command if that option is provided via earbud sensors.

In various embodiments, the system may provide visual confirmation options via connected devices, such as watches or mobile phones. The connected device may display the captured command text and request a quick tap or swipe for confirmation. In certain applications, such as augmented reality headsets or glasses, the user may see a low-confidence command text overlay.

The system may provide personalized shortcut suggestions: for example, the system may recommend probable commands (for example, frequently called contacts, commonly scheduled reminders). The system may also factor in location, time of day, or recurring user habits to refine likely command interpretations.

An example use case of the technology involves a user speaking a voice command in a noisy café. The in-canal microphone captures speech, but background chatter lowers the recognition confidence for “Remind me to call Sarah at 3 PM.” Automatically, the earbuds send a discreet haptic signal—two short taps—alerting the user that the system needs confirmation. Simultaneously, the user's smartwatch displays a prompt: “Did you say, ‘Call Sarah at 3 PM?’” With a single tap on the watch's display, the user confirms, avoiding the need for additional verbal repetition in a public space.

A potential application of the technology is in consumer earbuds and hearing aids, as the system may limit or reduce awkward re-queries in public, thereby improving user satisfaction with artificial intelligence agent. Another potential application is in workplace environments, as the system may allow employees to confirm voice commands in factories or offices without disrupting others. The system may also be utilized in healthcare and assistive devices to ensure patient or clinician commands are double-checked, thereby reducing the risk of critical errors. The system may also be utilized in military and security devices to minimize audible re-checks of voice commands in sensitive or high-noise settings.

One advantage of the technology is that the system may reduce repetition as users do not have to restate commands that fell below confidence thresholds, thereby saving time and avoiding frustration. Another advantage is that the system may provide enhanced privacy: in noisy or quiet public environments, discreet haptic and visual prompts replace extra voice prompts. Another advantage is that the system may provide improved accuracy: context-aware predictions and user history further minimize misinterpretation, leading to more precise outcomes. The system may also be implemented in existing wearable ecosystems, thereby supporting earbud and watch/phone synergy. The system may also be adaptive and scalable, as threshold tuning and multi-modal flexibility accommodate various usage styles and noise conditions.

FIG. 10 is a flow diagram illustrating an example method 1000 that aspects of the described technology may perform according to some embodiments. The method 1000 may begin at step 1002 where a first signal from one or more microphones of a first device worn by a wearer is received. The first device includes a haptic feedback component, a first user input component, and wireless communication circuitry. The first device is coupled to a second device via the wireless communication circuitry. The second device includes a display and a second user input component.

At step 1004, the first signal is processed to generate first data. At step 1006, the first data is provided to an artificial intelligence agent. At step 1008, a response and a confidence score is received from the artificial intelligence agent. At step 1010, it is determined that the confidence score is below a threshold. At step 1012, a request for a confirmation is provided to the wearer, by at least one of: providing a haptic alert via the haptic feedback component or providing a visual alert to the second device for display by the display. At step 1014, the confirmation is received from the wearer, by at least one of: receiving a first user input via the first user input component or receiving from the second device a second user input provided via the second user input component.

In some aspects, the techniques described herein relate to a method including: receiving a first signal from one or more microphones of a first device worn by a wearer, the first device including a haptic feedback component, a first user input component, and wireless communication circuitry, the first device coupled to a second device via the wireless communication circuitry, the second device including a display and a second user input component; processing the first signal to generate first data; providing the first data to an artificial intelligence agent; receiving a response and a confidence score from the artificial intelligence agent; determining that the confidence score is below a threshold; providing a request for a confirmation to the wearer, by at least one of: providing a haptic alert via the haptic feedback component; or providing a visual alert to the second device for display by the display; and receiving the confirmation from the wearer, by at least one of: receiving a first user input via the first user input component; or receiving from the second device a second user input provided via the second user input component.

### Multi-Modal Fallback System for Agent Communications

Traditional voice assistants rely predominantly on voice-based inputs and real-time network connectivity. When network conditions degrade or the user's environment becomes too noisy, these assistants often struggle to capture commands accurately or fail to respond at all. While some platforms offer text-based fallback, the transition between voice and text is usually not seamless, causing users to lose conversational context or repeat commands. Few solutions address the need for continuity across multiple modes, especially in the context of in-canal voice input, where ambient noise or occlusion effects can further degrade accuracy. As artificial intelligence agents become ubiquitous—used in cars, noisy workplaces, and areas with spotty connectivity—uninterrupted communication is essential. A user might start a conversation via in-canal microphone but run into poor network coverage or extreme background noise, rendering voice commands ineffective.

The described technology provides technical solutions to these technical problems. A system according to the described technology may monitor conversation quality and transition to another mode, such as a visual modality such as text or haptic feedback, without losing the user's place in the conversation. Additionally, predictive caching of likely responses (for example, local data for weather, directions, or personal notes) may allow the user to continue interacting with the agent even if connectivity is lost. Conversation state preservation may ensure that, upon returning to adequate network or quieter conditions, the dialogue may seamlessly continue where it left off.

The system may evaluate background interference and voice clarity in the user's ear canal as well as determine network strength, latency, and error rates to determine if voice-based communication remains feasible. The system may automatically switch between voice, visual modalities such as text, and haptic interaction. For example, the system may identify which mode best suits current conditions (for example, driving, high noise, no connectivity). The system may allow for preset user priorities in selecting a mode (for example, always switch to text if voice fails, or default to haptic in silent environments). The system may also learn common user queries, such as weather updates, directions, or daily schedules and predictively cache likely responses locally on the user device. If the network drops, the system can still provide pre-fetched responses or partial functionality.

The system may also maintain the thread of the conversation with the user so as to preserve conversation state across mode changes, thereby avoiding requiring the user to re-provide information. Furthermore, when switching back from offline or text modes, the system may synchronize agents with any new details.

An example use case involves a user wearing in-canal earbuds while traveling in a mountainous region with variable cellular coverage. At first, the user issues voice commands. Once the signal weakens, the system automatically switches to text-based interaction on a paired smartphone, preserving any partial conversation data. If the environment becomes too dangerous or inconvenient for texting (for example, driving or hiking), the system reverts to haptic prompts, prompting the user with simple touches to confirm or deny previously cached queries until connectivity or quieter conditions return.

Advantages of the technology include enhanced reliability, as the system may automatically adapt to fluctuating noise levels and network conditions, thereby reducing communication failures. The system may also facilitate a continuous user experience by retaining the conversation's context across voice, text, and haptic modes. Another advantage is that the predictive caching and context tracking may reduce redundant data transfers and user queries, thereby providing more efficient resource use. The system may offer multiple input/output methods which may meet various user abilities and situational requirements. The system may also be applicable to consumer, enterprise, and specialized devices that rely on artificial intelligence agent interactions.

### Conversation Security Classification and Response Methodology

Existing voice assistant and communication platforms generally use uniform response methods for all kinds of user queries. Regardless of whether a user is requesting a simple weather update or disclosing personal financial data, the output channel remains the same (for example, audible speaker output). This approach risks leaking confidential details in public or semi-public environments. While some systems incorporate user-defined privacy modes (for example, whisper mode, text-only), they often rely on manual toggling and fail to dynamically adapt as conversation topics evolve. Furthermore, these systems lack automated classification of conversation topics in real time, leading to potential oversights when users discuss multiple subjects of varying sensitivity.

A system according to the described technology provides technical solutions to these technical problems. The system may automatically classify conversation content in real time to adapt the response method (audio, haptic, bone conduction, etc.) in accordance with privacy sensitivity, ensuring secure and contextually appropriate communication. The system may enable context-aware privacy handling by scanning ongoing conversation content and applying predefined or user-set privacy thresholds. For example, if the user's conversation shifts from casual to sensitive banking questions, the system may upgrade to secure transmission, perhaps using bone conduction or haptic notifications. In case a user or system policy recognizes especially confidential content (for example, medical results), the system may adopt the most private channel available. Users can customize privacy tiers, so a high-sensitivity classification automatically suppresses audible responses while moderate-sensitivity classification could allow low-volume audio output. This adaptive mechanism may reduce the risk of inadvertently disclosing private information in public or shared spaces.

To analyze content in real-time, the system may use Natural Language Processing (NLP) algorithms to identify keywords and context to gauge the sensitivity of the communication. The system may compare detected content against user-defined or default classification rules (for example, personal data, financial info). The system may use one of multiple response modes based on the comparison: an audio output mode that may be used for low-sensitivity content or general inquiries, a haptic signals mode that may be used for moderate-sensitivity content, and a bone conduction mode for high-sensitivity content. Utilizing the bone conduction mode may minimize or reduce external audibility and ensure private playback for higher-security content.

The user may define privacy thresholds to tailor sensitivity levels (for example, low, medium, high) for various content categories. The user may also create custom profiles to allow for different contexts (work vs. personal) or environments (public vs. private). The system may allow the user to select a custom profile or may automatically select a custom profile based on context (for example, location). The system may dynamically switch modes during conversations. For example, once the system detects high-sensitivity content, the system may switch modes without interrupting the conversation. If the system detects low-sensitivity content, such as casual topics, the system may switch to a low-sensitivity mode.

An example use case involves a user wearing an in-ear device who initiates a conversation about general news. The system classifies this content as low-security and uses a conventional audio output. Partway through, the user pivots to credit card or health-related inquiries. As the classification engine flags the conversation as more sensitive, it transitions to bone conduction or haptic feedback to discreetly convey agent responses—protecting the user's privacy without requiring manual intervention.

Potential applications of the technology include corporate and enterprise settings. For example, the system may confidently handle confidential corporate strategies or sensitive human resources discussions through secure response methods. Another potential application includes healthcare environments, where the system may provide protected access to patient data or medical updates without risking audible disclosure in shared areas. Personal and financial services also may utilize the system: for example, the system may safeguard sensitive banking queries, investment details, or tax forms, thereby ensuring discretion in public spaces. Another potential application includes the military and the government, where the system may dynamically adapt to classified or high-security discussions in real time to prevent leaks.

Advantages of the technology include enhanced privacy: the system may minimize or reduce the risk of accidental exposure of sensitive data by switching to less audible or entirely silent feedback methods. Another advantage is given by the context-aware adaptation: NLP-driven classification logic may ensure that responses match the conversation's sensitivity, which may relieve users from manual mode toggling. Another advantage is provided by the customizable security levels: users or organizations can configure thresholds and response modes to align with privacy requirements or compliance regulations. The system may allow for continuous conversation flow: switching channels mid-conversation is seamless, preserving user engagement and minimizing disruption. The system may also be versatile in that the system may be deployed in consumer ear-worn devices, specialized security headsets, or integrated software solutions for broader communication systems.

FIG. 11 depicts a block diagram of an example digital device 1100 according to some embodiments. The digital device 1100 is shown in the form of a general-purpose computing device. The digital device 1100 includes at least one processor 1102, RAM 1104, communication interface 1106, input/output device 1108, storage 1110, and a system bus 1112 that couples various system components including storage 1110 to the at least one processor 1102. A system, such as a computing system, may be or include one or more of the digital devices 1100.

System bus 1112 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1100 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1102 is configured to execute executable instructions (for example, programs). In some embodiments, the at least one processor 1102 comprises circuitry or any processor capable of processing the executable instructions.

In some embodiments, RAM 1104 stores programs or data. In various embodiments, working data is stored within RAM 1104. The data within RAM 1104 may be cleared or ultimately transferred to storage 1110, such as prior to reset or powering down the digital device 1100.

In some embodiments, the digital device 1100 is coupled to a network, such as the communication network 212, via communication interface 1106. The digital device 1100 can communicate with one or more networks such as a local area network (LAN), a general wide area network (WAN), or a public network (for example, the Internet).

In some embodiments, input/output device 1108 is any device that inputs data (for example, mouse, keyboard, stylus, sensors, etc.) or outputs data (for example, speaker, display, virtual reality headset).

In some embodiments, storage 1110 can include computer system readable media in the form of non-volatile memory, such as read only memory (ROM), programmable read only memory (PROM), solid-state drives (SSD), flash memory, or cache memory. Storage 1110 may further include other removable/non-removable, volatile/non-volatile computer system storage media. By way of example only, storage 1110 can be provided for reading from and writing to a non-removable, non-volatile magnetic media. The storage 1110 may include a non-transitory computer-readable medium, or multiple non-transitory computer-readable media, which stores programs or applications for performing functions. Although not shown, a magnetic disk drive for reading from and writing to a removable, non-volatile magnetic disk (for example, a floppy disk), and an optical disk drive for reading from or writing to a removable, non-volatile optical disk such as a CDROM, DVD-ROM or other optical media can be provided. In such instances, each can be connected to system bus 1112 by one or more data media interfaces. As will be further depicted and described below, storage 1110 may include at least one program product having a set (for example, at least one) of program modules that are configured to carry out the functions of embodiments of the technologies described herein. In some embodiments, RAM 1104 is found within storage 1110.

Programs/utilities, having a set (at least one) of program modules, such as the property layout system, may be stored in storage 1110 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technologies described herein.

It should be understood that although not shown, other hardware or software components could be used in conjunction with the digital device 1100. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technologies may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technologies are described below with reference to flowchart illustrations or block diagrams of methods, apparatus (systems) and computer program products according to embodiments of the technologies. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

It may be apparent that various modifications may be made, and other embodiments may be used without departing from the broader scope of the discussion herein. For example, although an electrochromic window may be described as being in a transparent state in the absence of an electrical bias, the electrochromic window may be in a coloured state in the absence of an electrical bias. As another example, although electrochromic windows may be described for automobiles, any other type of vehicle that includes at least one electrochromic window may utilize the described technology. Therefore, these and other variations upon the example embodiments are intended to be covered by the disclosure herein.

1. A method comprising:
receiving a first signal from one or more in-canal microphones positioned in an ear canal of a wearer, the first signal generated from speech of the wearer captured by the one or more in-canal microphones, the one or more in-canal microphones included in a first portion of a device worn by the wearer, the first portion positioned at least partially in the ear canal, the first portion further including one or more sound output devices configured to output sounds in the ear canal;
receiving multiple second signals from multiple microphones included in a second portion of the device, the multiple second signals generated from the speech of the wearer;
processing the first signal to generate a first processed data set and the multiple second signals to generate a second processed data set;
providing the first processed data set and the second processed data set to one or more machine learning or artificial intelligence systems;
receiving one or more responses from the one or more machine learning or artificial intelligence systems;
generating, based on the one or more responses, a third signal; and
causing the one or more sound output devices to output sounds in the ear canal based on the third signal.

2. The method of claim 1 wherein the sounds are first sounds, and further comprising:
receiving multiple fourth signals from the multiple microphones, the multiple fourth signals generated from external sounds;
generating, based on the multiple fourth signals, multiple noise cancellation signals; and
causing the one or more sound output devices to output second sounds based on the multiple noise cancellation signals.

3. The method of claim 1 wherein the sounds are first sounds, and further comprising:
detecting second sounds output by the one or more sound output devices emanating from the ear canal;
generating, based on the second sounds, a noise cancellation signal; and
causing at least one sound output device to output third sounds based on the noise cancellation signal.

4. The method of claim 1 wherein providing the first processed data set to the one or more machine learning or artificial intelligence systems includes providing the first processed data set to at least one speech to text model configured for in-canal speech.

5. The method of claim 4, further comprising modifying at least one foundation model using in-canal speech data to generate the at least one speech to text model configured for in-canal speech.

6. The method of claim 1 wherein providing the first processed data set and the second processed data set to the one or more machine learning or artificial intelligence systems includes:
providing the first processed data set to multiple speech to text models configured for in-canal speech; and
receiving multiple responses and multiple confidence scores from the multiple speech to text models,
wherein generating, based on the one or more responses, the third signal includes generating, based on the multiple responses and the multiple confidence scores, the third signal.

7. The method of claim 1 wherein the device is a first device, the first device further includes one or more processors and wireless communication circuitry, the one or more machine learning or artificial intelligence systems include a first artificial intelligence agent, the one or more processors execute instructions for the first artificial intelligence agent, the one or more responses are one or more first responses, the sounds are first sounds, and further comprising:
detecting that the first device is not coupled to a second device via the wireless communication circuitry;
receiving a fourth signal from the one or more in-canal microphones;
processing the fourth signal to generate third data;
providing the third data to the first artificial intelligence agent;
receiving one or more second responses from the first artificial intelligence agent;
generating, based on the one or more second responses, a fifth signal; and
causing the one or more sound output devices to output second sounds based on the fifth signal.

8. One or more non-transitory computer-readable media comprising executable instructions that when executed by one or more processors of a system cause the system to perform a method comprising:
receiving a first signal from one or more in-canal microphones positioned in an ear canal of a wearer, the first signal generated from speech of the wearer captured by the one or more in-canal microphones, the one or more in-canal microphones included in a first portion of a device worn by the wearer, the first portion positioned at least partially in the ear canal, the first portion further including one or more sound output devices configured to output sounds in the ear canal;
receiving multiple second signals from multiple microphones included in a second portion of the device, the multiple second signals generated from the speech of the wearer;
processing the first signal to generate a first processed data set and the multiple second signals to generate a second processed data set;
providing the first processed data set and the second processed data set to one or more machine learning or artificial intelligence systems;
receiving one or more responses from the one or more machine learning or artificial intelligence systems;
generating, based on the one or more responses, a third signal; and
causing the one or more sound output devices to output sounds in the ear canal based on the third signal.

9. The one or more non-transitory computer-readable media of claim 8 wherein the sounds are first sounds, and the method further comprises:
receiving multiple fourth signals from the multiple microphones, the multiple fourth signals generated from external sounds;
generating, based on the multiple fourth signals, multiple noise cancellation signals; and
causing the one or more sound output devices to output second sounds based on the multiple noise cancellation signals.

10. The one or more non-transitory computer-readable media of claim 8, and the method further comprises:
detecting second sounds output by the one or more sound output devices emanating from the ear canal;
generating, based on the second sounds, a noise cancellation signal; and
causing at least one sound output device to output third sounds based on the noise cancellation signal.

11. The one or more non-transitory computer-readable media of claim 8 wherein providing the first processed data set to the one or more machine learning or artificial intelligence systems includes providing the first processed data set to at least one speech to text model configured for in-canal speech.

12. The one or more non-transitory computer-readable media of claim 11, the method further comprising modifying at least one foundation model using in-canal speech data to generate the at least one speech to text model configured for in-canal speech.

13. The one or more non-transitory computer-readable media of claim 8 wherein providing the first processed data set and the second processed data set to the one or more machine learning or artificial intelligence systems includes:
providing the first processed data set to multiple speech to text models configured for in-canal speech; and
receiving multiple responses and multiple confidence scores from the multiple speech to text models,
wherein generating, based on the one or more responses, the third signal includes generating, based on the multiple responses and the multiple confidence scores, the third signal.

14. The one or more non-transitory computer-readable media of claim 8 wherein the device is a first device, the first device further includes one or more processors and wireless communication circuitry, the one or more machine learning or artificial intelligence systems include a first artificial intelligence agent, the one or more processors execute instructions for the first artificial intelligence agent, the one or more responses are one or more first responses, the sounds are first sounds, and further comprising:
detecting that the first device is not coupled to a second device via the wireless communication circuitry;
receiving a fourth signal from the one or more in-canal microphones;
processing the fourth signal to generate third data;
providing the third data to the first artificial intelligence agent;
receiving one or more second responses from the first artificial intelligence agent;
generating, based on the one or more second responses, a fifth signal; and
causing the one or more sound output devices to output second sounds based on the fifth signal.

15. A device comprising:
a first portion configured to be positioned at least partially in an ear canal of a wearer, the first portion including:
one or more in-canal microphones configured to capture sounds or vibrations in the ear canal; and
one or more sound output devices configured to output sounds in the ear canal;
a second portion including multiple microphones configured to capture external sounds;
one or more processors; and
one or more memories storing instructions that upon execution by the one or more processors cause the device to perform a method, the method including:
receiving a first signal from the one or more in-canal microphones, the first signal generated from speech of the wearer captured by the one or more in-canal microphones,
receiving multiple second signals from the multiple microphones, the multiple second signals generated from the speech of the wearer;
processing the first signal to generate a first processed data set and the multiple second signals to generate a second processed data set;
providing the first processed data set and the second processed data set to one or more machine learning or artificial intelligence systems;
receiving one or more responses from the one or more machine learning or artificial intelligence systems;
generating, based on the one or more responses, a third signal; and
causing the one or more sound output devices to output sounds in the ear canal based on the third signal.
